(19) United States
(12) Patent Application Publication
(10) Pub. No.: US 2023/0376274 A1
(43) Pub. Date: Nov. 23, 2023

(54) FLOATING-POINT MULTIPLY-ACCUMULATE UNIT FACILITATING VARIABLE DATA PRECISIONS

(71) Applicant: Intel Corporation, Santa Clara, CA (US)

(72) Inventors: Mark Anders, Hillsboro, OR (US); Arnab Raha, San Jose, CA (US); Amit Agarwal, Hillsboro, OR (US); Steven Hsu, Lake Oswego, OR (US); Deepak Abraham Mathaikutty, Chandler, AZ (US); Ram K. Krishnamurthy, Portland, OR (US); Martin Power, Dublin (IE)

(73) Assignee: Intel Corporation, Santa Clara, CA (US)

(21) Appl. No.: 18/362,529

(22) Filed: Jul. 31, 2023

(51) Int. Cl. G06F 7/544; G06F 7/487; G06F 7/485; G06F 5/01

(52) U.S. Cl. CPC G06F 7/5443; G06F 7/4876; G06F 7/485; G06F 5/012

(57) ABSTRACT

A fused dot-product multiply-accumulate (MAC) circuit may support variable precisions of floating-point data elements to perform computations (e.g., MAC operations) in deep learning operations. An operation mode of the circuit may be selected based on the precision of an input element. The operation mode may be a FP16 mode or a FP8 mode. In the FP8 mode, product exponents may be computed based on exponents of floating-point input elements. A maximum exponent may be selected from the one or more product exponents. A global maximum exponent may be selected from a plurality of maximum exponents. A product mantissa may be computed and aligned with another product mantissa based on a difference between the global maximum exponent and a corresponding maximum exponent. An adder tree may accumulate the aligned product mantissas and compute a partial sum mantissa. The partial sum mantissa may be normalized using the global maximum exponent.

### TECHNICAL FIELD

This disclosure relates generally to multiply-accumulate (MAC) operations, and more specifically, floating-point MAC (FPMAC) units that can facilitate variable data precisions.

### BACKGROUND

Deep neural networks (DNNs) are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN accelerator, in accordance with various embodiments.

FIG. 4 illustrates an example processing element (PE) with an FPMAC unit, in accordance with various embodiments.

FIGS. 5A and 5B illustrate an FPMAC unit capable of mantissa multiply skipping, in accordance with various embodiments.

FIG. 6 illustrates an FPMAC unit supporting variable floating-point precisions, in accordance with various embodiments.

FIG. 7 illustrates FP16 mantissa computation in an FPMAC unit, in accordance with various embodiments.

FIGS. 8A and 8B illustrate FP8 mantissa computation in an FPMAC unit, in accordance with various embodiments.

FIGS. 9A and 9B illustrate data paths in an FPMAC unit supporting variable floating-point precisions, in accordance with various embodiments.

FIG. 10 illustrates a maximum exponent module with OR trees, in accordance with various embodiments.

FIG. 11 illustrates a PE array, in accordance with various embodiments.

FIG. 12 is a block diagram of a PE, in accordance with various embodiments.

FIG. 13 is a flowchart showing a method of performing FPMAC operations, in accordance with various embodiments.

FIG. 14 is a block diagram of an example computing device, in accordance with various embodiments.

### DETAILED DESCRIPTION

Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN layer may be performed on one or more internal parameters of the DNN layer and input data received by the DNN layer. The internal parameters (e.g., weights) of a DNN layer may be determined during the training phase.

The internal parameters or input data of a DNN layer may be elements of a tensor. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements” or “activations”), a weight tensor including one or more weights, and an output tensor (also referred to as “output feature map (OFM)”) including one or more output activations (also referred to as “output elements” or “activations”). A weight tensor of a convolution may be a kernel, a filter, or a group of filters.

The increase in sizes of DNNs leads to increases in the resources required for DNN training and inference. Larger width floating-point formats often fail to achieve high energy efficiency. Lower precision integer formats can achieve high energy efficiency, but often require extensive model tuning or optimizer hyperparameters. While narrow bit-width integer formats have shown some advantages for inference, FP8 can achieve desirable accuracy across a range of DNNs for both training and inference without requiring extensive tuning or optimizer hyperparameters. Many existing DNNs use FP16 (half-precision floating-point) formats, HF16 (an IEEE half-precision floating-point format), and BF16 (Brain floating-point) formats. However, FP8 (eight-bit floating-point) format can accelerate deep learning training and inference for better performance and energy efficiency. It can be beneficial to migrate to FP8 formats. However, currently available DNN accelerators usually support FP16 formats and various integer formats but fail to support FB8 formats.

Embodiments of the present disclosure provide DNN accelerators with FPMAC unit that can support variable FP formats, including FP16 and FP8 formats, such as HF16, BF16, HF8, BF8, other types of FP18 and FP8 formats, or some combination thereof. An FPMAC unit may include a fused dot-product MAC circuit with one or more merged data paths that support both FP16 and FP8 formats. In an example FPMAC unit, FP16 mantissa multiply may be reconfigured into a two-way FP8 dot-product to maximize the reuse of the hardware components for FP16 mantissa multiply. The reconfigurability can reduce energy overhead required for supporting FP8 formats.

In various embodiments, an FPMAC unit may support variable precisions of floating-point data elements to perform computations (e.g., MAC operations) in deep learning operations. A control module may select an operation mode of the FPMAC unit from a plurality of operation modes based on a precision of at least one of to-be-processed floating-point data elements. One or more product and alignment modules may operate in the selected operation mode.

In an example where the operation mode is for a floating-point data format with a lower precision (e.g., FP8 format), a product and alignment module in the FPMAC unit may compute one or more product exponents based on exponents of the floating-point data elements and select a maximum exponent from the one or more product exponents. This maximum exponent can also be referred to as a local maximum exponent as it is local to the product and alignment module. One or more local maximum exponents computed by the one or more product and alignment modules in the FPMAC unit may be transmitted to a maximum exponent module in the FPMAC unit. The maximum exponent module may select a maximum exponent from the one or more maximum exponents. The maximum exponent selected by the maximum exponent module is also referred to as a global maximum exponent as it can apply to multiple or even all the product and alignment modules. The product and alignment module may also compute a product mantissa, one or more bits in which may be shifted based on a difference between the global maximum exponent and the local maximum exponent. The shifting can align the product mantissa with one or more other product mantissas. An adder tree in the FPMAC unit may accumulate aligned product mantissas and compute a partial sum mantissa. The partial sum mantissa may be normalized using the global maximum exponent. The result of the normalization may be the output of the FPMAC unit.

The FPMAC unit can skip computation of product mantissas in cases where the mantissa multiplication would not affect the output of the adder tree. In an example, a production mantissa would not be computed in a case that the product mantissa, if computed and aligned, would have a bit width (e.g., the number of bits) exceeding a bit width limit of the adder tree. The mantissa multiply skipping can be facilitated by using OR trees in the maximum exponent module to reduce time delay that would be needed to determine whether the bit width of the product mantissa would exceed the bit width limit. In another example, a production mantissa would not be computed in a case that another product mantissa is infinity or NaN (not a number). The mantissa multiply skipping can reduce energy consumed by the FPMAC unit for performing its computation.

With FPMAC units configurable for both FP16 and FP8 formats, the present disclosure can enable significant area reduction compared to separate FP16 and FP8 dot-product implementations. The energy overhead of the combined reconfigurable design can be minimal while supporting multiple input format encodings.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” means (A), (B), or (A and B). For the purposes of the present disclosure, the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

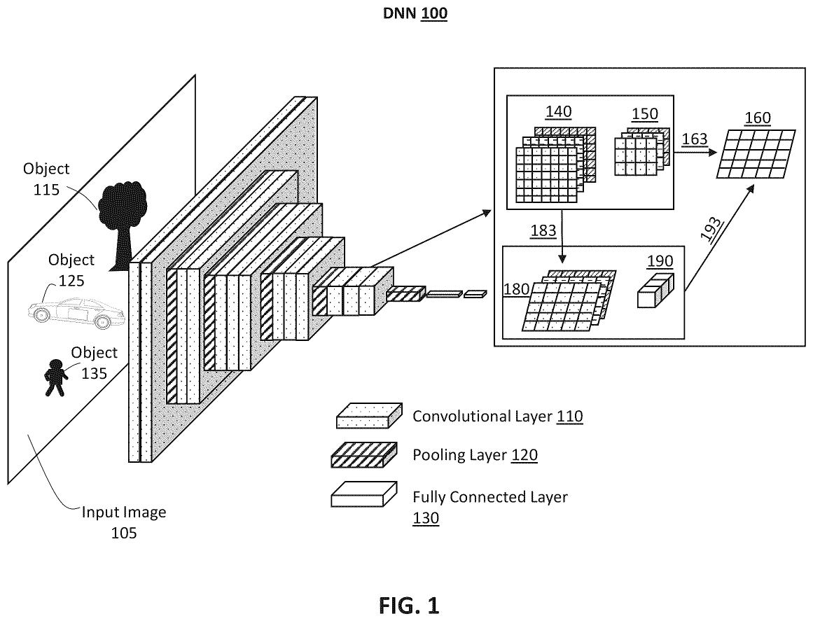

FIG. 1 illustrates an example DNN 100, in accordance with various embodiments. For the purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is Reu. Elu is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

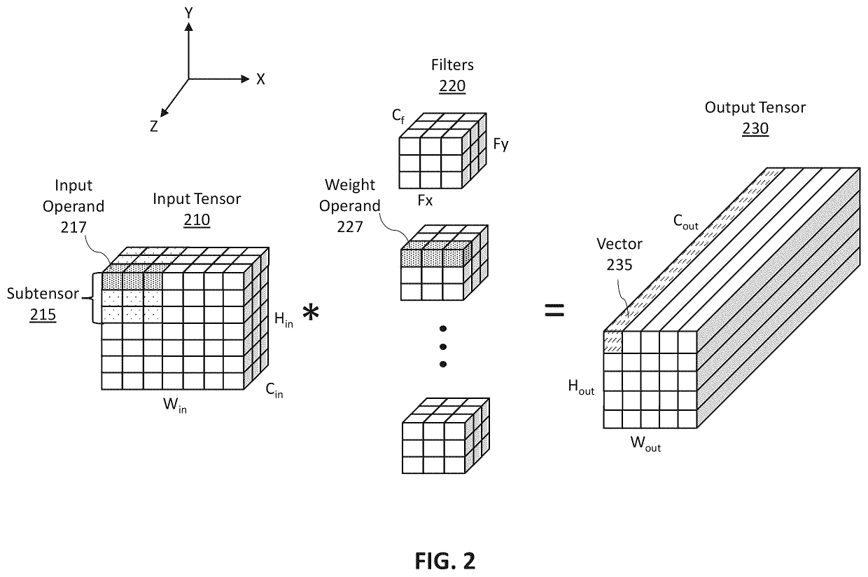

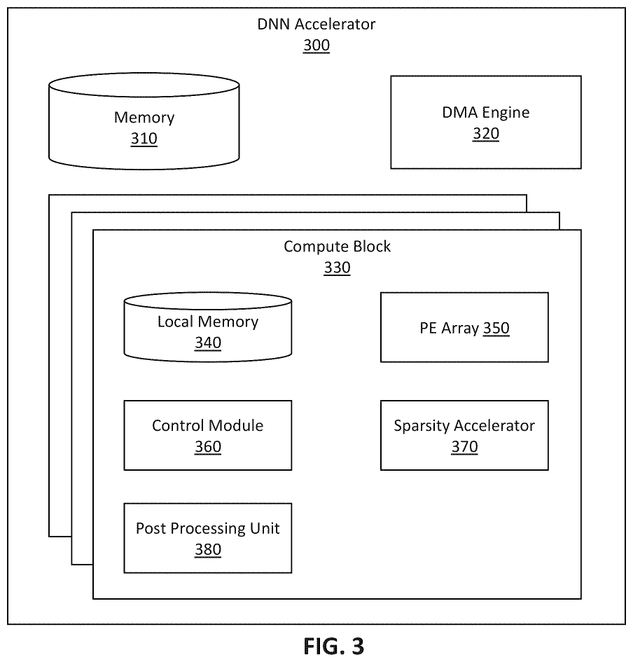

FIG. 2 illustrates an example convolution, in accordance with various embodiments. The convolution may be a convolution in a convolutional layer of a DNN, e.g., a convolutional layer 110 in FIG. 1. The convolutional layer may be a frontend layer. The convolution can be executed on an input tensor 210 and filters 220 (individually referred to as “filter 220”). A result of the convolution is an output tensor 230. In some embodiments, the convolution is performed by a DNN accelerator including one or more compute block. An example of the DNN accelerator may be the DNN accelerator 300 in FIG. 3. Examples of the compute blocks may be the compute blocks 325 in FIG. 3.

In the embodiments of FIG. 2, the input tensor 210 includes activations (also referred to as “input activations,” “elements,” or “input elements”) arranged in a 3D matrix. An activation in the input tensor 210 is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An activation in the output tensor 230 is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with dot patterns in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230.

After the vector 235 is produced, further MAC operations are performed to produce additional vectors till the output tensor 230 is produced. For instance, a filter 220 may move over the input tensor 210 along the X axis or the Y axis, and MAC operations can be performed on the filter 220 and another subtensor in the input tensor 210 (the subtensor has the same size as the filter 220). The amount of movement of a filter 220 over the input tensor 210 during different compute rounds of the convolution is referred to as the stride size of the convolution. The stride size may be 1 (i.e., the amount of movement of the filter 220 is one activation), 2 (i.e., the amount of movement of the filter 220 is two activations), and so on. The height and width of the output tensor 230 may be determined based on the stride size.

In some embodiments, the MAC operations on a 3×3×3 subtensor (e.g., the subtensor 215) and a filter 220 may be performed by a plurality of PEs. One or more PEs may receive an activation operand (e.g., an activation operand 217 shown in FIG. 2) and a weight operand (e.g., the weight operand 227 shown in FIG. 2). The activation operand 217 includes a sequence of activations having the same (Y, Z) coordinate but different X coordinates. The weight operand 227 includes a sequence of weights having the same (Y, Z) coordinate but different X coordinates. The length of the activation operand 217 is the same as the length of the weight operand 227. Activations in the activation operand 217 and weights in the weight operand 227 may be sequentially fed into a PE. The PE may receive an activation-weight pair, which includes an activation and its corresponding weight, at a time and multiple the activation and the weight. The position of the activation in the activation operand 217 may match the position of the weight in the weight operand 227.

Activations or weights may be floating-point numbers. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

Floating-point numbers may have various precisions and data formats, such as FP32 (single-precision floating-point) formats, FP16 formats, FP8 formats, and so on. A floating-point number having a FP16 format may be represented by 16 bits, including a sign bit, some bits (e.g., 5 bits or 8 bits) representing the exponent, and some bits (e.g., 10 bits or 7 bits) representing the mantissa. FP8 formats have lower precision than FP16 formats. A floating-point number having a FP8 format may be represented by 8 bits, including a sign bit, some bits (e.g., 5 bits or 4 bits) representing the exponent, and some bits (e.g., 2 bits or 3 bits) representing the mantissa.

Th multiplication of a floating-point activation and a floating-point weight may include computation of a product exponent based on the exponents of the two floating-point numbers and computation of a product mantissa based on the mantissas of the two floating-point numbers. The product exponent may be the sum of the two exponents. The product mantissa may be a multiplication product of the two mantissas.

To add the products of a plurality of activation-weight pairs, the product mantissas may be aligned by shifting bits in the product mantissas based on the product exponents. For instance, a maximum exponent may be selected from the product exponents, and the difference between the maximum exponent and the product exponent of an activation-weight pair may determine the amount to shift one or more bits in the product mantissa of the activation-weight pair. The shifted product mantissas may be accumulated to compute a partial sum mantissa, which can further be normalized based on the maximum exponent.

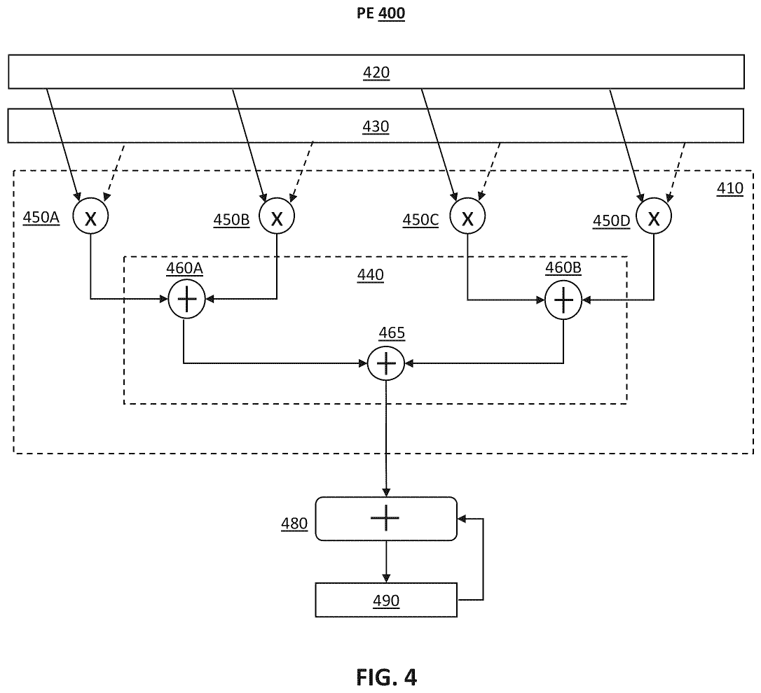

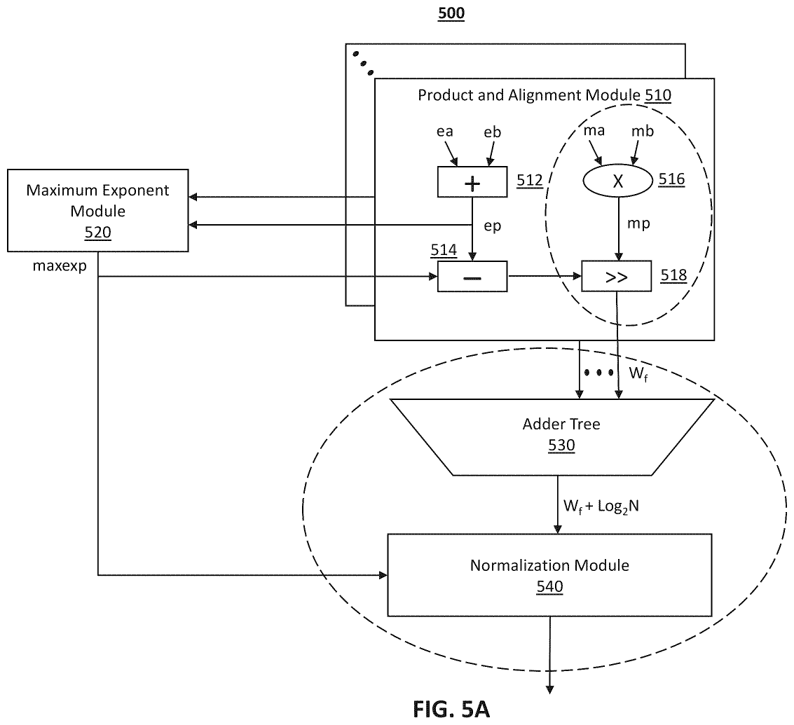

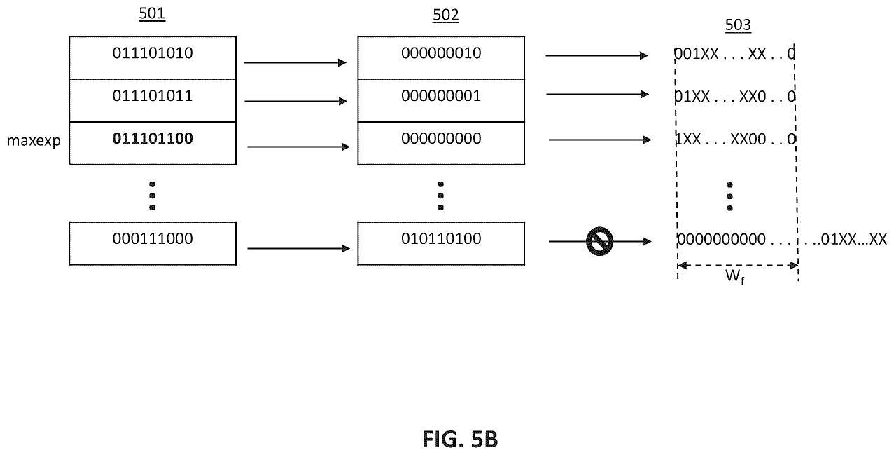

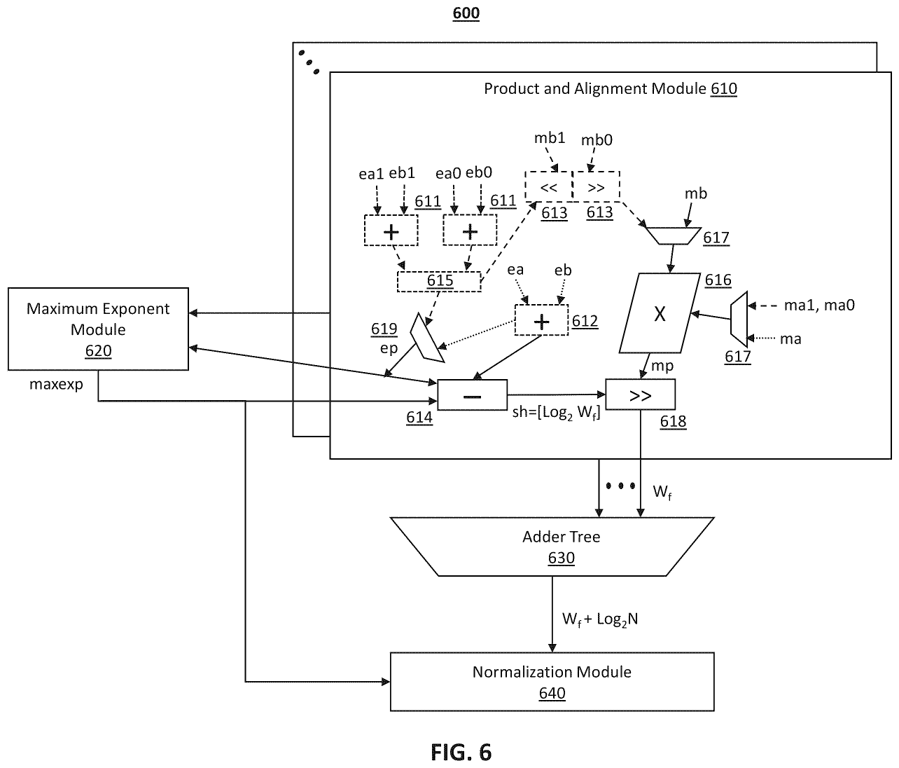

In some embodiments, the number of mantissa bits in a floating-point number may need to be adjusted (e.g., some bits in the mantissa may need to be truncated) to meet the number of mantissa bits in the target FP format. Further, the exponent bits may be determined based on the number of exponent bits in the FP format. Normalization of an FP number may include a change of the exponential form of the FP number, e.g., to meet the FP format. In some embodiments, normalization of a floating-point number may include removal of one or more leading zeros in the floating-point number. The leading zeros may be zero valued bits that come before nonzero valued bits in the floating-point number. A normalized floating-point number may have no leading zeros. Also, the decimal point may be moved, and the exponent may be adjusted in accordance with the removal of the leading zeros. The result of the normalization may be the result of the MAC operation on the plurality of activation-weight pairs. MAC operations on floating-point activations and floating-point weights may be performed by PEs with FPMAC units, such as the FPMAC unit 410 in FIG. 4, The FPMAC unit 500 in FIG. 5A, or the FPMAC unit 600 in FIG. 6.

Example DNN Accelerator

FIG. 3 is a block diagram of a DNN accelerator 300, in accordance with various embodiments. The DNN accelerator 300 can execute deep learning operations in DNNs. The DNN accelerator 300 may be used for DNN training and inference. In the embodiments of FIG. 3, the DNN accelerator 300 includes a memory 310, a DMA (direct memory access) engine 320, and compute block 330 (individually referred to as “compute block 330”). In other embodiments, alternative configurations, different or additional components may be included in the DNN accelerator 300. For example, the DNN accelerator 300 may include more than one memory 310 or DMA engine 320. As another example, the DNN accelerator 300 may include a single compute block 330. Further, functionality attributed to a component of the DNN accelerator 300 may be accomplished by a different component included in the DNN accelerator 300 or by a different system. A component of the DNN accelerator 300 may be implemented in hardware, software, firmware, or some combination thereof.

The memory 310 stores data associated with deep learning operations performed by the DNN accelerator 300. In some embodiments, the memory 310 may store data to be used by the compute blocks 330 for performing deep learning operations. For example, the memory 310 may store weights, such as weights of convolutional layers, which are determined by training DNNs. The memory 310 may also store data generated by the compute blocks 330 from performing deep learning operations in DNNs. Example deep learning operations include convolutions (also referred to as “convolutional operations”), pooling operations, elementwise operations, activation functions, other types of deep learning operations, or some combination thereof. The memory 310 may be a main memory of the DNN accelerator 300. In some embodiments, the memory 310 includes one or more DRAMs (dynamic random-access memory).

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 can perform deep learning operations in DNNs. For instance, a compute block 330 may run a deep learning operation in a DNN layer, or a portion of the deep learning operation, at a time. The compute blocks 330 may be capable of running various types of deep learning operations, such as convolution, pooling, elementwise operation, linear operation, nonlinear operation, and so on. In an example, a compute block 330 may perform convolutions, e.g., standard convolution or depthwise convolution. In some embodiments, the compute block 330 receives an input tensor and one or more convolutional kernels and performs a convolution with the input tensor and convolutional kernels. The result of the convolution may be an output tensor, which can be further computed, e.g., by the compute block 330 or another compute block 330. In some embodiments, the operations of the DNN layers may be run by multiple compute blocks 330 in parallel. For instance, multiple compute blocks 330 may each perform a portion of a workload for a convolution. Data may be shared between the compute blocks 330. A compute block 330 may also be referred to as a compute tile. In some embodiments, each compute block 330 may be a processing unit.

In the embodiments of FIG. 3, each compute block 330 includes a local memory 340, a PE array 350, a control module 360, a sparsity accelerator 370, and a post processing unit 380. Some or all the components of the compute block 330 can be implemented on the same chip. In other embodiments, alternative configurations, different or additional components may be included in the compute block 330. Further, functionality attributed to a component of the compute block 330 may be accomplished by a different component included in the compute block 330, a different compute block 330, another component of the DNN accelerator 300, or a different system. For example, the control module 360 may be not part of the compute block 330 or not part of the DNN accelerator 300. As another example, the control module 360 may be part of the PE array 350, part of a PE column in the PE array 350, or part of a PE in the PE array 350. A component of the compute block 330 may be implemented in hardware, software, firmware, or some combination thereof.

The local memory 340 is local to the corresponding compute block 330. In the embodiments of FIG. 3, the local memory 340 is inside the compute block 330. In other embodiments, the local memory 340 may be outside the compute block 330. The local memory 340 may store data received, used, or generated by the PE array 350 and the post processing unit 380. Examples of the data may include input activations, weights, output activations, sparsity bitmaps, and so on. Data in the local memory 340 may be transferred to or from the memory 310, e.g., through the DMA engine 320. In some embodiments, data in the local memory 340 may be transferred to or from the local memory of another compute block 330.

In some embodiments, the local memory 340 includes one or more static random-access memories (SRAMs). The local memory 340 may be byte-addressable, and each memory address identifies a single byte (eight bits) of storage. In some embodiments, the local memory 340 may include memory banks. The number of data banks in the local memory 340 may be 16, 64, 128, 356, 512, 1024, 3048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format or a floating-point number in a FP8 format, versus two storage units may be needed to store a number in a FP16 or BF16 format, which has 16 bits. In some embodiments, 16 bits can be transferred from the local memory 340 in a single read cycle. In other embodiments, 16 bits can be transferred from the local memory 340 in multiple read cycles, such as two cycles.

The PE array 350 may include PEs arranged in columns, or columns and rows. Each PE can perform MAC operations. In some embodiments, a PE includes one or more multipliers for performing multiplications. An PE may also include one or more accumulators (also referred to as “adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. APE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 350 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 350 may output multiple output operands at a time, each of which is generated by a different PE. In a standard convolution, MAC operations may include accumulations across the channels. For instance, as opposed to generating an output operand, a PE may accumulate products across different channels to generate a single output point.

A PE in the PE array 350 may include one or more configurable FPMAC units that can process floating-point data elements in various precisions, including FP16 and FP8 formats. Examples of FPMAC units include FPMAC unit 410 in FIG. 4, The FPMAC unit 500 in FIG. 5A, and the FPMAC unit 600 in FIG. 6. AN FPMAC unit may include a fused dot-product MAC circuit with one or more merged data paths for floating-point data with different precisions. In some embodiments, the FPMAC unit may receive configuration signals from the control module 360 and operate in accordance with the configuration signals. For instance, the FPMAC unit may have multiple operation modes for processing data with different precisions. A configuration signal may indicate in which operation mode the FPMAC unit would operate.

The control module 360 controls operation modes of FPMAC units in the PE array 350. In some embodiments, the control module 360 may control the operation mode of an FPMAC unit based on the precision of data to be processed by the FPMAC unit. For instance, the control module 360 may determine whether the precision of the data is a lower precision or a higher precision. The control module 360 may determine the precision of the data based on the data format. For instance, data with a FP16 format may be determined to have the higher precision, and data with a FP8 format may be determined to have the lower precision. In an embodiment, the control module 360 may generate a configuration signal in response to determining that the precision of the data is the lower precision and transmit the configuration signal to the FPMAC unit. The configuration signal may configure the operation mode of the FPMAC unit to a mode that can be used to process data elements with the lower precision. In response to determining that the precision of the data is the higher precision, the control module 360 may generate a different configuration signal and transmit the different configuration signal to the FPMAC unit. The different configuration signal may configure the operation mode of the FPMAC unit to a different mode that can be used to process data elements with the higher precision.

In some embodiments, the control module 360 may transmit the same configuration signal to multiple FPMAC units, e.g., FPMAC units that are used to perform MAC operations in a convolution with floating-point activations or floating-point weights. The control module 360 may provide different configuration signals to the same FPMAC unit at different times, e.g., in different computation rounds in which the FPMAC unit processes data with different precisions.

The control module 360 may also control clock cycles in operations of the FPMAC units, e.g., through one or more clocks. AN FPMAC unit may use multiple cycles to compute a product of a floating-point activation and a floating-point weight. In an embodiment, an MAC operation on an activation operand and a weight operand may include three or more cycles. The FPMAC unit may compute product exponents of the activation-weight pairs and find the maximum exponent in the first cycle. In the second cycle, the FPMAC unit may compute product mantissas and align the product mantissas. In the third cycle, the FPMAC unit may accumulate the aligned product mantissas and normalize the sum.

The control module 360 may facilitate skipping mantissa multiply in the second cycle in some embodiments, such as embodiments where the result of the mantissa multiply would not impact the result of the MAC operation, or the result of the mantissa multiply is already known. In an example, before the start of the second cycle, the control module 360 may determine whether to skip the second cycle and the third cycle based on the product exponents and maximum exponent. The control module 360 may determine whether a product mantissa, if shifted (e.g., shifted based on the difference between the maximum exponent and the corresponding product exponent), would have a bit width exceeding a bit width limit.

The bit width may be the number of bits in the product mantissa after being shifted. The bit width limit may be the bit width limit of the adder tree in the FPMAC unit that would calculate the product mantissa with other product mantissas. The adder tree may be implemented with a fixed width, resulting in truncation of product mantissas when alignment causes large shifts beyond its width. While this data-dependent situation occurs with many floating-point addition operations that require alignment, it can become more likely as the number of terms increases within the fused dot-product. The energy expended in calculating a product mantissa would be wasted when it is not used within the adder tree. Thus, mantissa multiply skipping can reduce the amount of power needed for the MAC operation without impacting the output of the MAC operation. The control module 360 may compare the alignment shift amount to a threshold related to the adder tree width. After determining the bit width of the product mantissa would exceed the bit width limit, the control module 360 may transmit a gating signal to the FPMAC unit. After receiving the gating signal, the FPMAC unit may skip computations in the second cycle and the third cycle.

In another embodiment, the control module 360 may generate and provide the gating signal for skipping mantissa multiply when the adder tree result can be known without the mantissa multiplication, e.g., if one of the multipliers generates an infinity or NaN. These conditions must be determined during the first cycle for the gating signal to be available before the start of the second cycle.

The sparsity accelerator 370 accelerates computations in the PE array 350 based on sparsity in activations or weights. In some embodiments (e.g., embodiments where the compute block 330 executes a convolutional layer), a computation in a PE may be a MAC operation on an input operand and a weight operand. The input operand may include one or more activations in the input tensor of the convolution. Different activations may be in different input channels. The weight operand may include one or more weights in the filter of the convolution. The values of the weights are determined through training the DNN. The weights in the weight operand may be in different input channels.

In some embodiments, the input operand is associated with an activation bitmap, which may be stored in the local memory 340. The activation bitmap can indicate positions of the nonzero-valued activations in the input operand. The activation bitmap may include a plurality of bits, each of which corresponds to a respective activation in the input operand. The position of a bit in the activation bitmap may match the position of the corresponding activation in the input operand. A bit in the activation bitmap may be zero or one. A zero valued bit indicates that the value of the corresponding activation is zero, a one valued bit indicates that the value of the corresponding activation is nonzero. In some embodiments, the activation bitmap may be generated during the execution of another DNN layer, e.g., a layer that is arranged before the convolutional layer in the DNN.

In some embodiments, the weight operand is associated with a weight bitmap, which may be stored in the local memory 340. The weight bitmap can indicate positions of the nonzero-valued weights in the weight operand. The weight bitmap may include a plurality of bits, each of which corresponds to a respective weight in the weight operand. The position of a bit in the weight bitmap may match the position of the corresponding weight in the weight operand. A bit in the weight bitmap may be zero or one. A zero valued bit indicates that the value of the corresponding weight is zero, a one valued bit indicates that the value of the corresponding weight is nonzero.

In some embodiments, the sparsity accelerator 370 may receive the activation bitmap and the weight bitmap and generate a combined sparsity bitmap for the MAC operation to be performed by the PE. In some embodiments, the sparsity accelerator 370 generates the combined sparsity bitmap 735 by performing one or more AND operations on the activation bitmap and the weight bitmap. Each bit in the combined sparsity bitmap is a result of an AND operation on a bit in the activation bitmap and a bit in the weight bitmap, i.e., a product of the bit in the activation bitmap and the bit in the weight bitmap. The position of the bit in the combined sparsity bitmap matches the position of the bit in the activation bitmap and the position of the bit in the weight bitmap. A bit in the combined bitmap corresponds to a pair of activation and weight (activation-weight pair). A zero bit in the combined sparsity bitmap indicates that at least one of the activation and weight in the pair is zero. A one bit in the combined sparsity bitmap indicates that both the activation and weight in the pair are nonzero. The combined sparsity bitmap may be stored in the local memory 340.

The sparsity accelerator 370 may provide activations and weights to the PE based on the combined sparsity bitmap. For instance, the sparsity accelerator 370 may identify one or more nonzero-valued activation-weight pairs from the local memory 340 based on the combined sparsity bitmap. The local memory 340 may store input operands and weight operands in a compressed format so that nonzero-valued activations and nonzero-valued weights are stored but zero valued activations and zero valued weights are not stored. The nonzero-valued activation(s) of an input operand may constitute a compressed input operand. The nonzero-valued weight (s) of a weight operand may constitute a compressed weight operand. For a nonzero-valued activation-weight pair, the sparsity accelerator 370 may determine a position the activation in the compressed input operand and determine a position of the weight in the compressed weight operand based on the activation bitmap, weight bitmap, and the combined bitmap. The activation and weight can be read from the local memory 340 based on the positions determined by the sparsity accelerator 370.

In some embodiments, the sparsity accelerator 370 includes a sparsity acceleration logic that can compute position bitmaps based on the activation bitmap and weight bitmap. The sparsity accelerator 370 may determine position indexes of the activation and weight based on the position bitmaps. In an example, the position index of the activation in the compressed input operand may equal the number of one(s) in an activation position bitmap generated by the sparsity accelerator 370, and the position index of the weight in the compressed weight operand may equal the number of one(s) in a weight position bitmap generated by the sparsity accelerator 370. The position index of the activation or weight indicates the position of the activation or weight in the compressed input operand or the compressed weight operand. The sparsity accelerator 370 may read the activation and weight from one or more memories based on their position indexes.

The sparsity accelerator 370 can forward the identified nonzero-valued activation-weight pairs to the PE. The sparsity accelerator 370 may skip the other activations and the other weights, as they will not contribute to the result of the MAC operation. In some embodiments, the local memory 340 may store the nonzero-valued activations and weights and not store the zero valued activations or weights. The nonzero-valued activations and weights may be loaded to one or more register files of the PE, from which the sparsity accelerator 370 may retrieve the activations and weights corresponding to the ones in the combined sparsity bitmap. In some embodiments, the total number of ones in the combined sparsity bitmap equals the total number of activation-weight pairs that will be computed by the PE, while the PE does not compute the other activation-weight pairs. By skipping the activation-weight pairs corresponding to zero bits in the combined sparsity bitmap, the computation of the PE will be faster, compared with the PE computing all the activation-weight pairs in the input operand and weight operand.

The sparsity accelerator 370 may be implemented in hardware, software, firmware, or some combination thereof. In some embodiments, at least part of the sparsity accelerator 370 may be inside a PE. Even though FIG. 4 shows a single sparsity accelerator 370, the compute block 330 may include multiple sparsity accelerator s. In some embodiments, every PE in the PE array 350 is implemented with a sparsity accelerator 370 for accelerating computation and reducing power consumption in the individual PE. In other embodiments, a subset of the PE array 350 (e.g., a PE column or multiple PE columns in the PE array 350) may be implemented with a sparsity accelerator 370 for acceleration computations in the subset of PEs.

The post processing unit 380 processes outputs of the PE array 350. In some embodiments, the post processing unit 380 computes activation functions. The post processing unit 380 may receive outputs of the PE array 350 as inputs to the activation functions. The post processing unit 380 may transmit the outputs of the activation functions to the local memory 340. The outputs of the activation functions may be retrieved later by the PE array 350 from the local memory 340 for further computation. For instance, the post processing unit 380 may receive an output tensor of a DNN layer from the PE array 350 and computes one or more activation functions on the output tensor. The results of the computation by the post processing unit 380 may be stored in the local memory 340 and later used as input tensor of the next DNN layer. In addition or alternative to activation functions, the post processing unit 380 may perform other types of post processing on outputs of the PE array 350. For instance, the post processing unit 380 may apply a bias on an output of the PE array 350.

In some embodiments, the local memory 340 is associated with a load path and a drain path may be used for data transfer within the compute block 330. For instance, data may be transferred from the local memory 340 to the PE array 350 through the load path. Data may be transferred from the PE array 350 to the local memory 340 through the drain path. The post processing unit 380 may be arranged on the drain path for processing outputs of the PE array before the data is written into the local memory 340.

Example FPMAC Unit in PE

FIG. 4 illustrates an example PE 400 with an FPMAC unit 410, in accordance with various embodiments. The PE 400 also includes an input storage unit 420, a weight storage unit 430, an accumulator 480, and an output storage unit 490. The FPMAC unit 410 includes multipliers 450A-D (collectively referred to as “multipliers 450” or “multiplier 450”) and an adder tree 440. The adder tree 440 includes adders 460A and 460B and an adder 465. In other embodiments, alternative configurations, different or additional components may be included in the PE 400. For example, the PE 400 may include more than one FPMAC unit. The FPMAC unit 410 may include a different number of multipliers. The adder tree 440 may include a different number of adders. Further, functionality attributed to a component of the PE 400 may be accomplished by a different component included in the PE 400, a different component included in a PE array where the PE 400 is placed, or by a different system. The positions of the components of the PE 400 in FIG. 4 are for the purpose of illustration only. Even though the positions of the components may reflect the direction of data flow in the PE 400, the positions of the components in FIG. 4 do not necessarily represent physical positions of the components in the PE 400.

The PE 400 may perform sequential cycles of MAC operations. In a cycle of MAC operations, the PE 400 may process multiple input operands and multiple weight operands, e.g., given the presence of multiple multipliers 450 in the FPMAC unit 410. Activations may be provided to the input storage unit 420 and stored in the input storage unit 420. In some embodiments, the input storage unit 420 may store activations of up to four input operands in the cycle of MAC operations. Weights may be provided to the weight storage unit 430 and stored in the weight storage unit 430. The weight storage unit 430 may store weights of up to four weight operands in the cycle of MAC operations. The multipliers 450 may fetch activations and weights from the input storage unit 420 and weight storage unit 430 and compute products. In an example round, each multiplier 450 receives an activation and a corresponding weight and outputs the product of the activation and the weight. In other cycles, the activations and weights may be reused by different multipliers 450. The activations and weights from the input storage unit 420 and weight storage unit 430 may be reused more than once.

An activation or weight may be a data element with a floating-point format, such as FP16 or FP8. In some embodiments, a multiplier 450 may compute an 8-way FP16 dot product or a 16-way FP8 dot product. A multiplier 450 may have two or more operation modes. For instance, the multiplier 450 may have a FP16 operation mode for computing 8-way FP16 dot products as well as a FP8 operation mode for computing 16-way FP8 dot products. More details regarding the FP16 operation mode and FP8 operation mode are provided below in conjunction with FIGS. 6, 7, 8A and 8B.

The adder tree 440 receives dot products computed by the multiplier 450 and accumulates the dot products. In some embodiments, a dot product received by the adder tree 440 may be an aligned product mantissa. The adder 460A receives products computed by the multipliers 450A and 450B and computes a first sum. The adder 460B receives products computed by the multiplier 450C and 450D and computes a second sum. The adder 465 receives the first sum and the second sum from the pipeline registers 470A and 470B and accumulates the sums to generate an output of the FPMAC unit 410. Even though not shown in FIG. 4, the FPMAC unit 410 may include a normalization module that can normalize the output of the adder tree 440.

The output of the FPMAC unit 410 is further provided to the accumulator 480. The accumulator 480 may accumulate the output of the FPMAC unit 410 with a value stored in the output storage unit 490. The value may be an output of another PE 400, which has been sent to the PE 400 and stored in the output storage unit 490. The output of the accumulator 480 can be stored in the output storage unit 490.

FIGS. 5A and 5B illustrate an FPMAC unit 500 capable of mantissa multiply skipping, in accordance with various embodiments. The FPMAC unit 500 may be an embodiment of the FPMAC unit 410 in FIG. 4. As shown in FIG. 5A, the FPMAC unit 500 includes product and alignment modules 510 (individually referred to as “product and alignment module 510”), a maximum exponent module 520, an adder tree 530, and a normalization module 540. The product and alignment modules 510 and maximum exponent module 520 may be an embodiment of the multipliers 450 in the FPMAC unit 410 in FIG. 4. The adder tree 530 and normalization module 540 may be an embodiment of the adder tree 440 in the FPMAC unit 410 in FIG. 4.

In other embodiments, alternative configurations, different or additional components may be included in the FPMAC unit 500. Further, functionality attributed to a component of the FPMAC unit 500 may be accomplished by a different component included in the FPMAC unit 500, a different component included in a PE where the FPMAC unit 500 is placed, or by a different device. The positions of the components of the FPMAC unit 500 in FIG. 5 are for the purpose of illustration only. Even though the positions of the components may reflect the direction of data flow in the FPMAC unit 500, the positions of the components in FPMAC unit 500 do not necessarily represent physical positions of the components in the FPMAC unit 500.

The FPMAC unit 500 may receive an activation operand comprising a sequence of floating-point activations and a weight operand comprising a sequence of floating-point weights. The activations and weights may be distributed to the product and alignment modules 510. For instance, a product and alignment module 510 may receive an activation and a weight. The product and alignment module 510 may compute a product exponent and a product mantissa based on the floating-point activation-weight pair.

As shown in FIG. 5A, a product and alignment module 510 includes an adder 512, a subtractor 514, a multiplier 516, and a shifter 518. The adder 512 may accumulate the exponent (represented by “ea” in FIG. 5A) of the first floating-point number (e.g., the activation) with the exponent (represented by “eb” in FIG. 5A) of the second floating-point number (e.g., the weight) to compute a product exponent (represented by “ep” in FIG. 5A). The product exponent may be transmitted to the maximum exponent module 520.

The maximum exponent module 520 may receive different product exponents from different product and alignment modules 510, such as the product exponents listed in the table 501 in FIG. 58. The maximum exponent module 520 outputs a maximum exponent (represented by “maxexp” in FIGS. 5A and 5B), which may be the largest product exponent received by the maximum exponent module 520. In the embodiments of FIG. 5B, the maximum exponent is the third product exponent in the table 501. The maximum exponent module 520 provides the maximum exponent to the subtractor 514 in each product and alignment module 510 that has provided a product exponent to the maximum exponent module 520.

The subtractor 514 in a product and alignment module 510 may subtract the product exponent computed by the adder 512 from the maximum exponent, or vice versa, to compute a difference between the product exponent and the maximum exponent. The difference is transmitted to the shifter 518. The difference may also be referred to as the shifting factor. The table 502 in FIG. 5B lists the differences between the product exponents in the table 501 and the maximum exponent in the table 501.

The multiplier 516 multiplies the mantissa (represented by “ma” in FIG. 5A) of the first floating-point number with the mantissa (represented by “mb” in FIG. 5A) of the second floating-point number to compute a product mantissa (represented by “mp” in FIG. 5A). The product mantissa may be transmitted to the shifter 518.

The shifter 518 shifts one or more bits in the product mantissa based on the difference computed by the subtractor 514. The shifting of the product mantissa in the product and alignment modules 510 can align the product mantissas computed by these product and alignment modules 510 and output aligned product mantissas, such as the ones listed in the table 503 in FIG. 5B. The alignment can facilitate the accumulation of the product mantissas by the adder tree 530.

In some embodiments, the operations of the adder 512, maximum exponent module 520, and subtractor 514 may be performed in the first clock cycle, while the operations of the multiplier 516 and shifter 518 may be perform in the second clock cycle, which is after the first clock cycle. The operations of the multiplier 516 and shifter 518 may be skipped in some embodiments. In an example, the operations of the multiplier 516 and shifter 518 may be skipped when the amount of shifting by the shifter 518 exceeds a threshold, e.g., a threshold shift amount that can cause the product mantissa, if shifted, to exceed a fixed bit width of the adder tree 530 (represented by “W_{f}” in FIGS. 5A and 5B). As shown in FIG. 5B, the bit width of the last aligned product mantissa in the table 503 exceeds the fixed bit width of the adder tree 530. Accordingly, the operations of the multiplier 516 and shifter 518 for computing the last aligned product mantissa in the table 503 can be skipped.

In another example, the operations of the multiplier 516 and shifter 518 may be skipped when the output of the adder tree 530 can be known without the product mantissa to be computed, e.g., another product and alignment module 510 has output an infinity or NaN product mantissa. In some embodiments, a product and alignment module 510 may receive a gating signal, e.g., from the control module 360. After receiving the gating signal, the product and alignment modules 510 skips the operations of the multiplier 516 and shifter 518 in the second cycle.

The adder tree 530 may receive one or more aligned product mantissas from the product and alignment modules 510. The adder tree 530 may include a plurality of adders (not shown in FIG. 5A or 5B) that are arranged in tiers. The number of adders in the first tier may be half of the number of product and alignment modules 510 in the FPMAC unit 500. Each adder in the first tier may be associated with two product and alignment modules 510 and accumulate the aligned product mantissas computed by the two product and alignment modules 510. The number of adders in the second tier may be half of the number of adders in the first tier. This may continue till the last tier, which may have a single adder. Each adder may receive two numbers and output the sum of the two numbers.

The output of the adder tree 530 (“partial sum mantissa”) may have a bit width equal to W_{f}+Log₂N, where N is the number of aligned product mantissas that are accumulated by the adder tree 530. The partial sum mantissa is transmitted to the normalization module 540. Also, the maximum exponent is transmitted to the normalization module 540. The normalization module 540 may normalize the partial sum mantissa based on the maximum exponent, e.g., by shifting one or more bits in the partial sum mantissa based on the maximum exponent. The result of the normalization may be the result of the MAC operation.

FIG. 6 illustrates an FPMAC unit 600 supporting variable floating-point precisions, in accordance with various embodiments. The FPMAC unit 600 may be an embodiment of the FPMAC unit 410 in FIG. 4. As shown in FIG. 6, the FPMAC unit 600 includes product and alignment modules 610 (individually referred to as “product and alignment module 610”), a maximum exponent module 620, an adder tree 630, and a normalization module 640. The product and alignment modules 610 and maximum exponent module 620 may be an embodiment of the multipliers 450 in the FPMAC unit 410 in FIG. 4. The adder tree 630 and normalization module 640 may be an embodiment of the adder tree 440 in the FPMAC unit 410 in FIG. 4.

In other embodiments, alternative configurations, different or additional components may be included in the FPMAC unit 600. Further, functionality attributed to a component of the FPMAC unit 600 may be accomplished by a different component included in the FPMAC unit 600, a different component included in a PE where the FPMAC unit 600 is placed, or by a different device. The positions of the components of the FPMAC unit 600 in FIG. 6 are for the purpose of illustration only. Even though the positions of the components may reflect the direction of data flow in the FPMAC unit 600, the positions of the components in FPMAC unit 600 do not necessarily represent physical positions of the components in the FPMAC unit 600.

The FPMAC unit 600 may receive an activation operand comprising a sequence of floating-point activations and a weight operand comprising a sequence of floating-point weights. The activations and weights may be distributed to the product and alignment modules 610. For instance, a product and alignment module 610 may receive an activation and a weight. The product and alignment module 610 may compute a product exponent and a product mantissa based on the floating-point activation-weight pair.

The FPMAC unit 600 (particularly the product and alignment modules 610) may be configurable for multiple operation modes, such as a FP16 mode, a FP8 mode, and so on. The operation mode of the FPMAC unit 600 may be controlled by the control module 360. In some embodiments, the FPMAC unit 600 may support multiple formats for each precision. For instance, the FPMAC unit 600 may support E5M10 and E8M7 for FP16 or support E5M2 and E4M3 for FP8, e.g., using the wider of the possible exponent widths and mantissa widths. Each FP16 or FP8 input element may be in a different format. The FPMAC unit 600 may reuse a higher precision multiplier to compute a lower precision dot product, by performing a local exponent difference and alignment in the lower precision mode. In an example, a multiplier may compute a×b in the FP16, versus it may compute a×b+c×d in FP8 mode it calculates. In some embodiments, FP8 input elements may be packed within the same bits as FP16 input elements such that two FP8 input elements may fit in the same bit width as a single FP16 input elements.

In the FP16 mode, a product and alignment module 610 receives an activation and a weight in FP16 formats. An adder 612 in the product and alignment module 610 may accumulate the exponent (represented by “ea” in FIG. 6) of the first floating-point number (e.g., the activation) with the exponent (represented by “eb” in FIG. 6) of the second floating-point number (e.g., the weight) to compute a product exponent (represented by “ep” in FIG. 6). The product exponent may be transmitted to the maximum exponent module 620.

The maximum exponent module 620 may receive different product exponents from different product and alignment modules 610. The maximum exponent module 620 outputs a maximum exponent, which may be the largest product exponent received by the maximum exponent module 620. The maximum exponent module 620 provides the maximum exponent to the subtractor 614 in each product and alignment module 610 that has provided a product exponent to the maximum exponent module 620. A subtractor 614 in a product and alignment module 610 may subtract the product exponent computed by the adder 612 from the maximum exponent, or vice versa, to compute a difference between the product exponent and the maximum exponent. The difference is transmitted to the shifter 618.

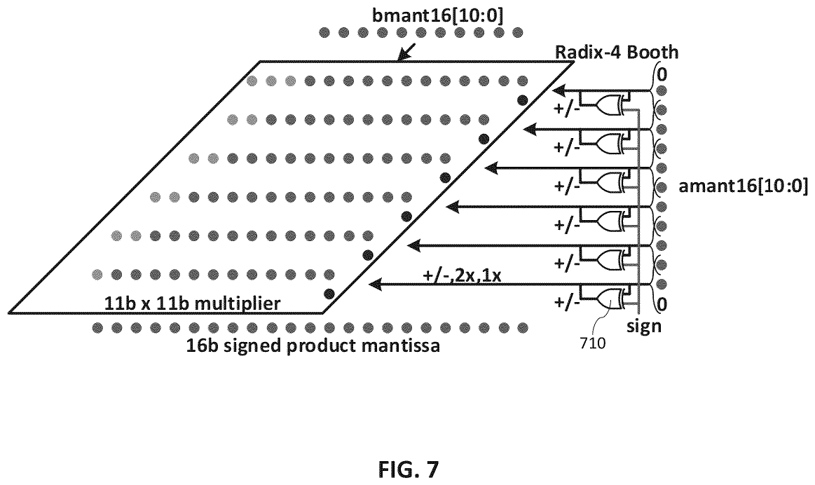

A multiplier 616 in the product and alignment module 610 multiplies the mantissa (represented by “ma” in FIG. 6) of the first floating-point number with the mantissa (represented by “mb” in FIG. 6) of the second floating-point number to compute a product mantissa (represented by “mp” in FIG. 6). The product mantissa may be transmitted to the shifter 618. A shifter 618 in the product and alignment module 610 shifts one or more bits in the product mantissa based on the difference computed by the subtractor 614. The shifting of the product mantissa in the product and alignment modules 610 can align the product mantissas computed by these product and alignment modules 610 and output aligned product mantissas. The alignment can facilitate the accumulation of the product mantissas by the adder tree 630. More details regarding the FP16 mode are described below in conjunction with FIG. 7.

In the FP8 mode, a product and alignment module 610 may receive two activations and two weights in FP8 formats for a computation round. An adder 611 in the product and alignment module 610 may accumulate the exponent (represented by “ea0” in FIG. 6) of an activation with the exponent (represented by “eb0” in FIG. 6) of a weight to compute a first product exponent. Another adder 611 may accumulate the exponent (represented by “ea1” in FIG. 6) of the other activation with the exponent (represented by “eb1” in FIG. 6) of the other weight to compute a second product exponent. The two product exponents are transmitted to a max finder 615, which selects the higher product exponent as the local maximum exponent (represented by “ep” in FIG. 6). The local maximum exponent may be transmitted to the maximum exponent module 620. The difference (or absolute difference) between the product exponents may also be transmitted to shifters 613 in the product and alignment module 610. In some embodiments, the max finder 615 may include a subtractor to compute the difference (or absolute difference).

The maximum exponent module 620 may receive multiple local maximum exponents from different product and alignment modules 610. The maximum exponent module 620 outputs a global maximum exponent (represented by “max ep” in FIG. 6), which may be the largest maximum exponent received by the maximum exponent module 620. The maximum exponent module 620 provides the global maximum exponent to the subtractor 614 in each product and alignment module 610 that has provided a maximum product exponent to the maximum exponent module 620. A subtractor 614 in a product and alignment module 610 may subtract the maximum product exponent computed by the adder 612 from the global maximum exponent, or vice versa, to compute a difference. The difference is transmitted to the shifter 618.

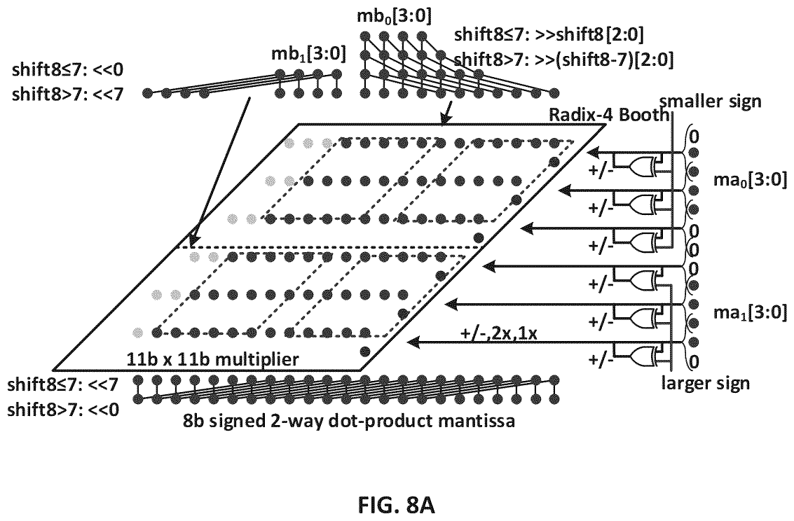

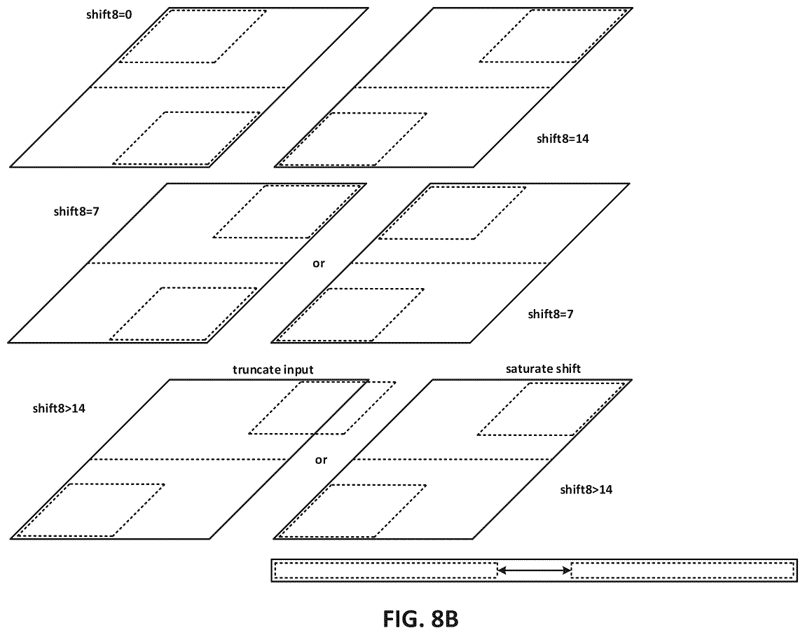

The shifters 613 may align the mantissas (represented by “mb0” and “mb1” in FIG. 6) of two floating-point numbers (e.g., the two weights or the two activations) based on the maximum exponent determined by the max finder 615. The aligned mantissas and the mantissas of the other two floating-point numbers (e.g., the two activations or the two weights) are transmitted to the multiplier 616 through multiplexers 617. The multiplier 616 accumulates the mantissas (represented by “ma” in FIG. 6) and compute a product mantissa (represented by “mp” in FIG. 6). The product mantissa may be a two-way dot product. The product mantissa may be transmitted to the shifter 618. More details regarding the FP8 mode are described below in conjunction with FIGS. 8A and 8B.

In both the FP16 mode and the FP8 mode, a shifter 618 in the product and alignment module 610 shifts one or more bits in the product mantissa based on the difference computed by the subtractor 614. The shifting of the product mantissa in the product and alignment modules 610 can align the product mantissas computed by these product and alignment modules 610 and output aligned product mantissas. The alignment can facilitate the accumulation of the product mantissas by the adder tree 630.

The adder tree 630 may receive one or more aligned product mantissas from the product and alignment modules 610. The adder tree 630 may include a plurality of adders (not shown in FIG. 6) that are arranged in tiers. The number of adders in the first tier may be half of the number of product and alignment modules 610 in the FPMAC unit 600. Each adder in the first tier may be associated with two product and alignment modules 610 and accumulate the aligned product mantissas computed by the two product and alignment modules 610. The number of adders in the second tier may be half of the number of adders in the first tier. This may continue till the last tier, which may have a single adder. Each adder may receive two numbers and output the sum of the two numbers. In some embodiments, the adder tree 630 may keep intermediate sums in a carry-save format. In an example, each adder in the adder tree 630 may receive four numbers (e.g., two carry-save numbers) and output two numbers (e.g., one carry-save number).

The output of the adder tree 630 (“partial sum mantissa”) may have a bit width equal to W_{f}+Log₂N, where N is the number of aligned product mantissas that are accumulated by the adder tree 630. The partial sum mantissa is transmitted to the normalization module 640. Also, the maximum exponent is transmitted to the normalization module 640. The normalization module 640 may normalize the partial sum mantissa based on the maximum exponent, e.g., by shifting one or more bits in the partial sum mantissa based on the maximum exponent. The result of the normalization may be the result of the MAC operation.

The FPMAC unit 600 may be capable of mantissa multiply skipping as described above. In the FP16 mode, the operations in the multiplier 616 and shifter 618 may be in a cycle after the cycle in which the operations in the adder 612, maximum exponent module 620, and subtractor 614 are performed. The operations in the multiplier 616 and shifter 618 may be skipped based on a gating signal, e.g., from the control module 360. In the FP8 mode, the operations in the shifters 613, multiplier 616, and shifter 618 may be in a cycle after the cycle in which the operations in the adders 611, max finder 615, maximum exponent module 620, and subtractor 614 are performed. The operations in the shifters 613, multiplier 616, and shifter 618 may be skipped based on a gating signal, e.g., from the control module 360.

FIG. 7 illustrates FP16 mantissa computation in an FPMAC unit, in accordance with various embodiments. An embodiment of the FPMAC unit may be the FPMAC unit 500 in FIG. 5A or the FPMAC unit 600 in FIG. 6. In the embodiments of FIG. 7, a mantissa multiplier (e.g., the multiplier 616) may be reconfigured to support a single FP16 mantissa multiply at a time. A dot in FIG. 7 represents a bit.

In the embodiments of FIG. 7, the FPMAC unit operates in a FP16 mode with one of the inputs (amant16) Booth encoded with +/−, 2×, and 1× signals. Negation of these unsigned inputs is performed within the multiplier by negating the +/−Booth signal when the product sign (XOR of the signs of the two inputs) is 1. As shown in FIG. 7, six XOR gates 710 (individually referred to as “XOR gate 710”) are used to determine the product sign. The usage of these XOR gates can lead to lower area consumption compared to negating either the mantissa inputs or multiplier output, both of which would require much more XOR gates (e.g., 22 XOR gates) and adding extra 1's. In some embodiments, the mantissas may be unsigned, while the booth-encoded partial products are signed. By inverting the sign booth select, neither the input mantissas (e.g., amant16 or bmant16) nor output product mantissa need to be separately negated. The extra 1's (because 2's complement negation involves inverting the bits and adding 1) may already be included in the multiplier when a partial product is negative, providing further power savings.

FIGS. 8A and 8B illustrate FP8 mantissa computation in an FPMAC unit, in accordance with various embodiments. An embodiment of the FPMAC unit may be the FPMAC unit 600 in FIG. 6. In the embodiments of FIGS. 8A and 8B, a mantissa multiplier (e.g., the multiplier 616) may be reconfigured to two FP8 mantissa multiplications along with summation of the two products at a time. In FIG. 8A, the sorted FP8 mantissas of one of the inputs are Booth encoded with the two 4b mantissas (i.e., mantissas each having four bits) aligned to the top (larger exponent) and bottom (smaller exponent) 4b of the 11b mantissa input. In this case, the negation may be split into two, with the sign corresponding to the smaller exponent negating the +/−Booth signals for the lower Booth rows and the sign corresponding to the larger exponent negating the +/−Booth signals for the upper Booth rows. In some embodiments, ma1 and mb1 may be the mantissas corresponding to the larger product exponent between each pair of FP8 product exponents. When ea1+eb1>ea0+eb0, ma1, ma0, mb1, mb0 may be left as is. When ea1+eb1<ea0+eb0, ma1 and ma0 may be swapped, and mb1 and mb0 may be swapped. Relative alignment of the two products may be achieved by shifting the other input mantissas, in parallel with the Booth encoder. This can balance the Booth encoder delay of one of the multiplier inputs with the alignment delay for the other input.

As shown in FIG. 8A, the upper input (mb1) is used for the upper rows, while the lower input (mb0) is used for the lower rows. Several options for alignment can be used. The lower input may be aligned based on the least significant bits (LSBs) of the shift8 exponent difference, while the upper input may be shifted by 7 when the exponent difference is larger than 7, e.g., in embodiments where the FP8 mantissas are 4b and are aligned within an 11b multiplier. In other embodiment (e.g., embodiments where other floating-point formats are used), the shift amount may be different. A single stage shifter at the multiplier output then realigns the dot product to the top of the multiplier output to be ready for the global alignment and adder tree.

FIG. 8B shows various options for aligning FP8 mantissas. The alignment may be performed by the shifter(s) 613 in FIG. 6. When shift8=0, the mantissas are aligned vertically so that the multiplier product contains the correct sum of the two FP8 mantissa products. When shift8=14, which may be the maximum separation that can be achieved for the two FP8 mantissa products within the 11b×11b multiplier, the mantissas are aligned in opposite corners. For shift8 values between 0 and 14, multiple options exist for alignment, as shown in FIG. 8B for shift8=7. When the upper mantissa is not aligned to the top of the multiplier, either a final product alignment or adjustment of the exponent may be needed to maintain consistency. For large differences between the exponents that require truncation, one option is for the lower mantissa to be shifted out or truncated, resulting in loss of symmetry between the inputs. An alternate method saturates the lower mantissa shift so that no bits are truncated before the multiply. The multiplier output will then need an extra shift to insert extra sign extension bits in the middle of the product.

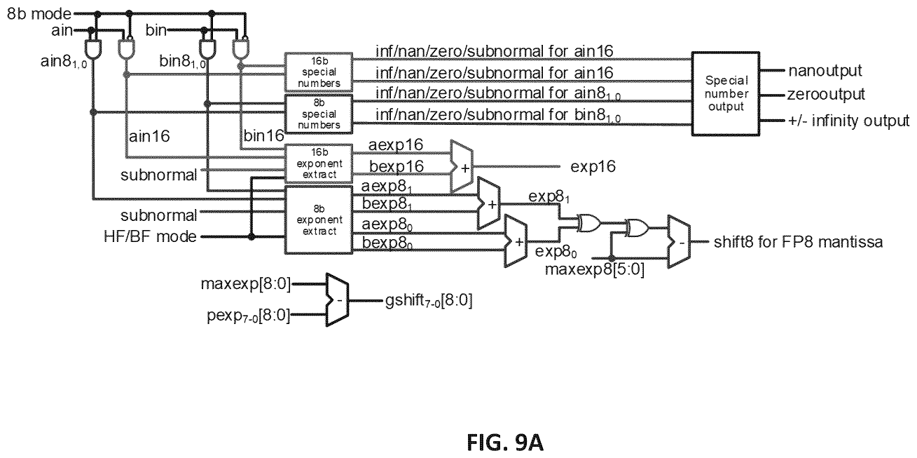

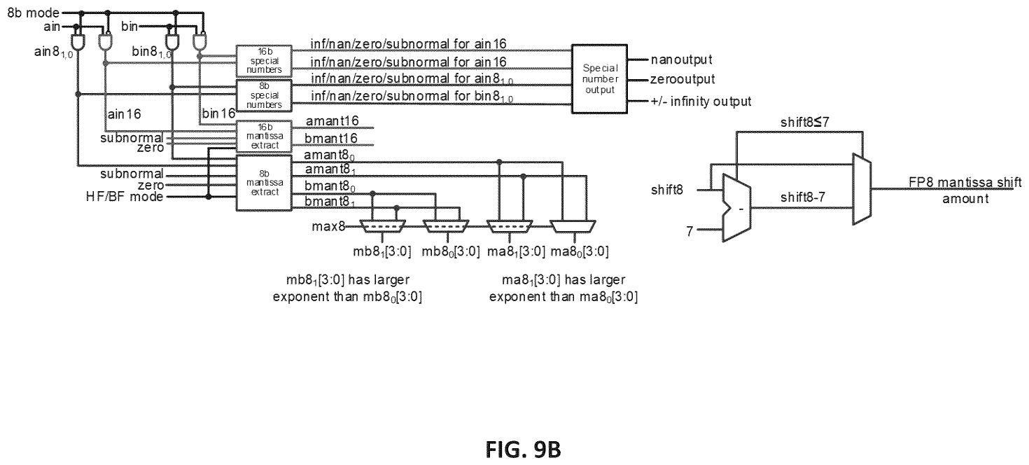

FIGS. 9A and 9B illustrate data paths in an FPMAC unit supporting variable floating-point precisions, in accordance with various embodiments. An embodiment of the FPMAC unit may be the FPMAC unit 600 in FIG. 6. In FIG. 9A, two inputs (ain and bin) are received. The two inputs may be a floating-point activation and a floating-point weight. The two inputs are gated with an 8b mode select signal to prevent switching on deselected portions of the datapath. A special number logic detects exponent and mantissa fields of all 1's or all 0's and sets the appropriate inf/nan/zero/subnormal signals. The 16b and 8b exponent extract logic uses a single stage shifter to align the exponent depending on encoding (e.g., HF or BF encoding), along with an OR of the LSB with the subnormal signal to set the exponent to 1 when subnormal. The product exponents (exp16 and exp8) may be computed by adding the input exponents. Using an XOR of the two FP8 exponents along with the maxexp8 results in the smaller exponent, which is then subtracted from the maximum exponent to find the FP8 mantissa shift amount.

The mantissa may be extracted from the inputs as shown in FIG. 9B, with a shift by 3 for 16b mode encodings and shift by 1 for 8b mode encodings correctly aligning the mantissas depending on the encoding. The leading one may be added when the value is not zero or subnormal. Following the local 8b maximum exponent logic, the 8b mantissas are sorted according to larger and smaller exponents within each pair. In some embodiments, the shift8 signal is subtracted and compared to 7, which may be the maximum shift possible for the FP8 mantissa within the 11b mantissa multiplier.

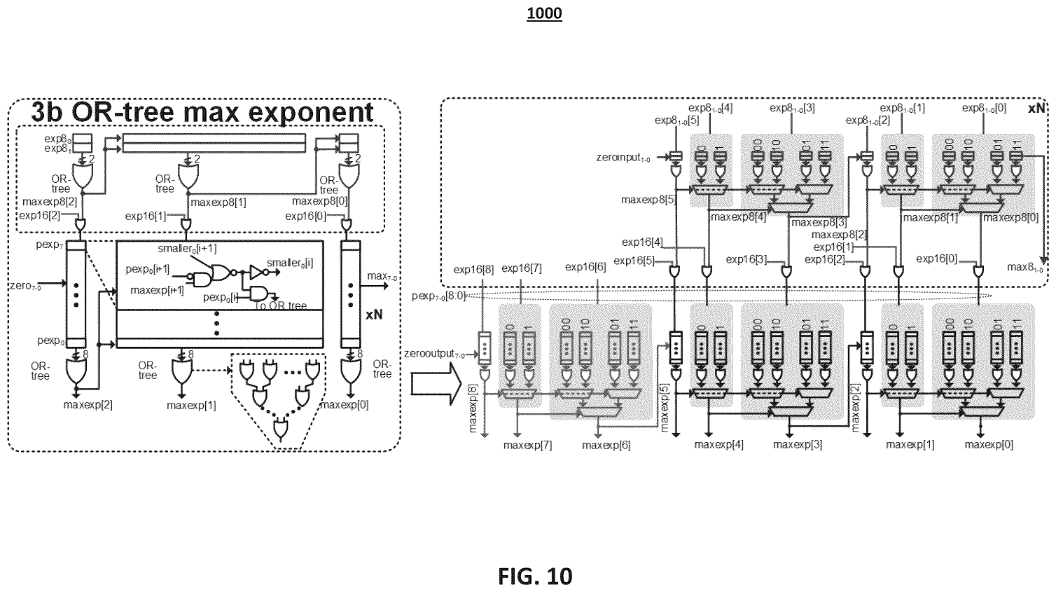

FIG. 10 illustrates a maximum exponent module 1000 with OR trees, in accordance with various embodiments. The maximum exponent module 1000 may be an embodiment of the maximum exponent module 520 in FIG. 5 or the maximum exponent module 620 in FIG. 6. In some embodiments (e.g., embodiments where mantissa multiply skipping may be used to save power), it can be timing critical to find whether the mantissa shift amount is larger than the fixed bit width of the adder tree to timely stop the mantissa multiply in the next clock cycle. This signal can be one of the conditions that determines whether the mantissa multiplier should be gated to reduce power.

In the embodiments of FIG. 10, a two-stage speculative OR-tree is used to reduce or minimize time delay caused by the determination of whether the mantissa shift amount is larger than the fixed bit width of the adder tree. The time delay in the two-stage speculative OR-tree can be less than the time delay in a tree-based compare-and-select implementation, especially for wide dot products with many terms.

In some embodiments, the maximum exponent module 1000 may start with the most significant bit (MSB). The maximum exponent module 1000 may OR the bits across all product exponents to determine if the maximum MSB bit is 1 or 0. The maximum exponent module 1000 may further combine the result of the OR operations with the individual product exponent MSB bits to find whether each product exponent is still in contention to determine the maximum exponent in a FP16 operation mode or the global maximum exponent in a FP8 operation mode. The resulting “smaller” signal may indicate that a particular product exponent is smaller than the maximum, e.g., because the incoming “smaller” signal is 1 or because the maximum exponent bit is 1 while the product exponent bit is 0.

The maximum exponent module 1000 may also use speculation to precompute the maxexp, which is the maximum exponent in a FP16 operation mode or the global maximum exponent in a FP8 operation mode, without knowing the higher bit maxexp value. In the embodiments of FIG. 10, there are two stages of speculation before continuing with the normal MSB-to-LSB signal dependency. In a case where a particular product exponent is known to be zero, the input “smaller” signal to the MSB OR-tree can be set to prevent that product from affecting the maximum exponent.

For the FP8 operation mode, a two-stage OR-tree may be used to find a local maximum product exponent (maxexp8) between each pair of products. This local maximum follows the same MSB-to-LSB arrival profile of the global maxexp. The upper 3b of the global find maximum logic may be removed from the critical path since the FP8 product exponents occupy only the lower 6b. Compared to a conventional compare and select implementation, the two-stage speculative OR-tree can achieve lower critical path delay. The upper 3b and lower 6b boundaries may depend on the floating-point formats of the input data. Different floating-point formats may have different boundaries.

Example PE Array

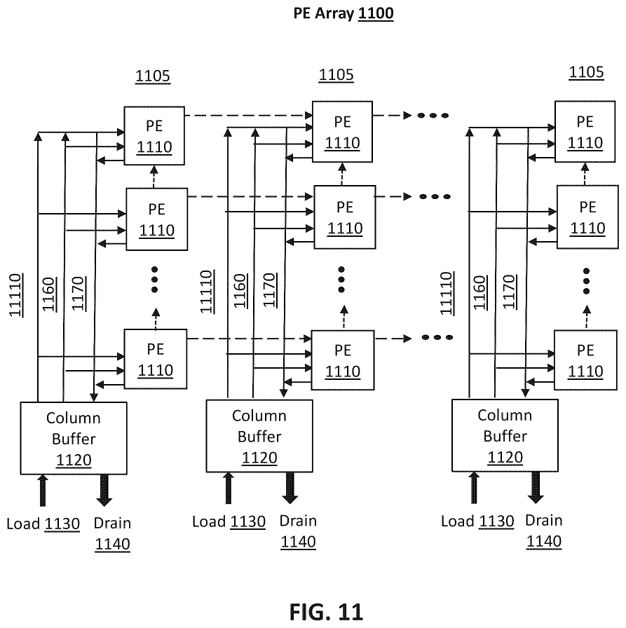

FIG. 11 illustrates a PE array 1100, in accordance with various embodiments. The PE array 1100 may be an embodiment of the PE array 350 in FIG. 3. The PE array 1100 includes a plurality of PEs 1110 (individually referred to as “PE 1110”). The PEs 1110 performs MAC operations. The PEs 1110 may also be referred to as neurons in the DNN. An embodiment of a PE 1110 may be the PE 400 in FIG. 4.

In the embodiments of FIG. 11, each PE 1110 has two input signals 1150 and 1160 and an output signal 1170. The input signal 1150 is at least a portion of an IFM to the layer. The input signal 1160 is at least a portion of a filter of the layer. In some embodiments, the input signal 1150 of a PE 1110 includes one or more activation operands, and the input signal 1160 includes one or more weight operands.

Each PE 1110 performs an MAC operation on the input signals 1150 and 1160 and outputs the output signal 1170, which is a result of the MAC operation. Some or all of the input signals 1150 and 1160 and the output signal 1170 may be in an integer format, such as INT8, or floating-point format, such as FP16 or BF16. For purpose of simplicity and illustration, the input signals and output signal of all the PEs 1110 have the same reference numbers, but the PEs 1110 may receive different input signals and output different output signals from each other. Also, a PE 1110 may be different from another PE 1110, e.g., including more, fewer, or different components.

As shown in FIG. 11, the PEs 1110 are connected to each other, as indicated by the dash arrows in FIG. 11. The output signal 1170 of an PE 1110 may be sent to many other PEs 1110 (and possibly back to itself) as input signals via the interconnections between PEs 1110. In some embodiments, the output signal 1170 of an PE 1110 may incorporate the output signals of one or more other PEs 1110 through an accumulate operation of the PE 1110 and generates an internal partial sum of the PE array. More details about the PEs 1110 are described below in conjunction with FIG. 11B.

In the embodiments of FIG. 11, the PEs 1110 are arranged into columns 1105 (individually referred to as “column 1105”). The input and weights of the layer may be distributed to the PEs 1110 based on the columns 1105. Each column 1105 has a column buffer 1120. The column buffer 1120 stores data provided to the PEs 1110 in the column 1105 for a short amount of time. The column buffer 1120 may also store data output by the last PE 1110 in the column 1105. The output of the last PE 1110 may be a sum of the MAC operations of all the PEs 1110 in the column 1105, which is a column-level internal partial sum of the PE array 1100. In other embodiments, input and weights may be distributed to the PEs 1110 based on rows in the PE array 1100. The PE array 1100 may include row buffers in lieu of column buffers 1120. A row buffer may store input signals of the PEs in the corresponding row and may also store a row-level internal partial sum of the PE array 1100.

As shown in FIG. 11, each column buffer 1120 is associated with a load 1130 and a drain 1140. The data provided to the column 1105 is transmitted to the column buffer 1120 through the load 1130, e.g., through upper memory hierarchies, e.g., the local memory 340 in FIG. 3. The data generated by the column 1105 is extracted from the column buffers 1120 through the drain 1140. In some embodiments, data extracted from a column buffer 1120 is sent to upper memory hierarchies, e.g., the local memory 340 in FIG. 3, through the drain operation. In some embodiments, the drain operation does not start until all the PEs 1110 in the column 1105 has finished their MAC operations. Even though not shown in FIG. 11, one or more columns 1105 may be associated with an external adder assembly.

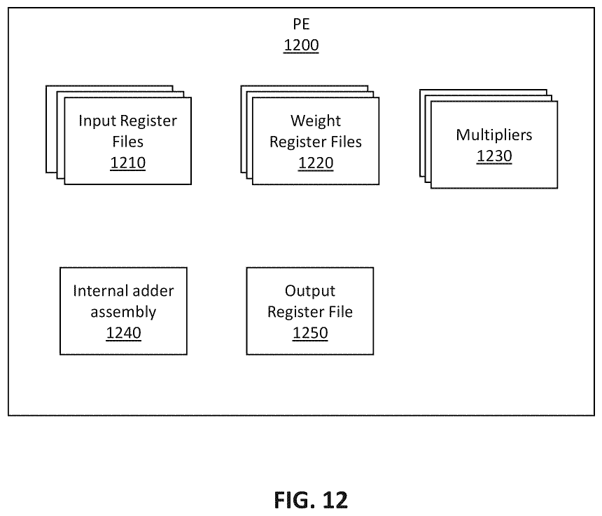

FIG. 12 is a block diagram of a PE 1200, in accordance with various embodiments. The PE 1200 may be an embodiment of the PE 1110 in FIG. 11. An embodiment of the PE 1200 may be the PE 400 in FIG. 4. The PE 1200 includes input register files 1210 (individually referred to as “input register file 1210”), weight registers file 1220 (individually referred to as “weight register file 1220”), multipliers 1230 (individually referred to as “multiplier 1230”), an internal adder assembly 1240, and an output register file 1250. In other embodiments, the PE 1200 may include fewer, more, or different components. For example, the PE 1200 may include multiple output register files 1250. As another example, the PE 1200 may include a single input register file 1210, weight register file 1220, or multiplier 1230. As yet another example, the PE 1200 may include an adder in lieu of the internal adder assembly 1240.

The input register files 1210 temporarily store activation operands for MAC operations by the PE 1200. In some embodiments, an input register file 1210 may store a single activation operand at a time. In other embodiments, an input register file 1210 may store multiple activation operand or a portion of an activation operand at a time. An activation operand includes a plurality of input elements (i.e., input elements) in an input tensor. The input elements of an activation operand may be stored sequentially in the input register file 1210 so the input elements can be processed sequentially. In some embodiments, each input element in the activation operand may be from a different input channel of the input tensor. The activation operand may include an input element from each of the input channels of the input tensor, and the number of input elements in an activation operand may equal the number of the input channels. The input elements in an activation operand may have the same (X, Y) coordinates, which may be used as the XY coordinates of the activation operand. For instance, all the input elements of an activation operand may be X0Y0, X0Y1, X1Y1, etc. An embodiment of the input register files 1210 may be the input storage unit 420 in FIG. 4.

The weight register file 1220 temporarily stores weight operands for MAC operations by the PE 1200. The weight operands include weights in the filters of the DNN layer. In some embodiments, the weight register file 1220 may store a single weight operand at a time. other embodiments, an input register file 1210 may store multiple weight operands or a portion of a weight operand at a time. A weight operand may include a plurality of weights. The weights of a weight operand may be stored sequentially in the weight register file 1220 so the weight can be processed sequentially. In some embodiments, for a multiplication operation that involves a weight operand and an activation operand, each weight in the weight operand may correspond to an input element of the activation operand. The number of weights in the weight operand may equal the number of the input elements in the activation operand.

In some embodiments, a weight register file 1220 may be the same or similar as an input register file 1210, e.g., having the same size, etc. The PE 1200 may include a plurality of register files, some of which are designated as the input register files 1210 for storing activation operands, some of which are designated as the weight register files 1220 for storing weight operands, and some of which are designated as the output register file 1250 for storing output operands. In other embodiments, register files in the PE 1200 may be designated for other purposes, e.g., for storing scale operands used in elementwise add operations, etc. An embodiment of the weight register files 1220 may be the weight storage unit 430 in FIG. 4.

The multipliers 1230 perform multiplication operations on activation operands and weight operands. A multiplier 1230 may perform a sequence of multiplication operations on a single activation operand and a single weight operand and generates a product operand including a sequence of products. Each multiplication operation in the sequence includes multiplying an input element in the activation operand and a weight in the weight operand. In some embodiments, a position (or index) of the input element in the activation operand matches the position (or index) of the weight in the weight operand. For instance, the first multiplication operation is a multiplication of the first input element in the activation operand and the first weight in the weight operand, the second multiplication operation is a multiplication of the second input element in the activation operand and the second weight in the weight operand, the third multiplication operation is a multiplication of the third input element in the activation operand and the third weight in the weight operand, and so on. The input element and weight in the same multiplication operation may correspond to the same depthwise channel, and their product may also correspond to the same depthwise channel.

Multiple multipliers 1230 may perform multiplication operations simultaneously. These multiplication operations may be referred to as a round of multiplication operations. In a round of multiplication operations by the multipliers 1230, each of the multipliers 1230 may use a different activation operand and a different weight operand. The different activation operands or weight operands may be stored in different register files of the PE 1200. For instance, a first multiplier 1230 uses a first activation operand (e.g., stored in a first input register file 1210) and a first weight operand (e.g., stored in a first weight register file 1220), versus a second multiplier 1230 uses a second activation operand (e.g., stored in a second input register file 1210) and a second weight operand (e.g., stored in a second weight register file 1220), a third multiplier 1230 uses a third activation operand (e.g., stored in a third input register file 1210) and a third weight operand (e.g., stored in a third weight register file 1220), and so on. For an individual multiplier 1230, the round of multiplication operations may include a plurality of cycles. A cycle includes a multiplication operation on an input element and a weight.

The multipliers 1230 may perform multiple rounds of multiplication operations. A multiplier 1230 may use the same weight operand but different activation operands in different rounds. For instance, the multiplier 1230 performs a sequence of multiplication operations on a first activation operand stored in a first input register file in a first round, versus a second activation operand stored in a second input register file in a second round. In the second round, a different multiplier 1230 may use the first activation operand and a different weight operand to perform another sequence of multiplication operations. That way, the first activation operand is reused in the second round. The first activation operand may be further reused in additional rounds, e.g., by additional multipliers 1230. An embodiment of a multiplier 1230 1210 may be the multiplier 450 in FIG. 4.

The internal adder assembly 1240 includes one or more adders inside the PE 1200, i.e., internal adders. The internal adder assembly 1240 may perform accumulation operations on two or more products operands from multipliers 1230 and produce an output operand of the PE 1200. In some embodiments, the internal adders are arranged in a sequence of tiers. A tier includes one or more internal adders. For the first tier of the internal adder assembly 1240, an internal adder may receive product operands from two or more multipliers 1230 and generate a sum operand through a sequence of accumulation operations. Each accumulation operation produces a sum of two or more products, each of which is from a different multiplier 1230. The sum operand includes a sequence of sums, each of which is a result of an accumulation operation and corresponds to a depthwise channel. For the other tier(s) of the internal adder assembly 1240, an internal adder in a tier receives sum operands from the precedent tier in the sequence. Each of these number may be generated by a different internal adder in the precedent tier. A ratio of the number of internal adders in a tier to the number of internal adders in a subsequent tier may be 2:1. In some embodiments, the last tier of the internal adder assembly 1240 may include a single internal adder, which produces the output operand of the PE 1200. An embodiment of the internal adder assembly 1240 may include the adder tree 440 or the accumulator 480 in FIG. 4.

The output register file 1250 stores output operands of the PE 1200. In some embodiments, the output register file 1250 may store an output operand at a time. In other embodiments, the output register file 1250 may store multiple output operands or a portion of an output operand at a time. An output operand includes a plurality of output elements in an IFM. The output elements of an output operand may be stored sequentially in the output register file 1250 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution. An embodiment of the output register file 1250 may include the output storage unit 490 in FIG. 4.

Example Method of Performing FPMAC Operations

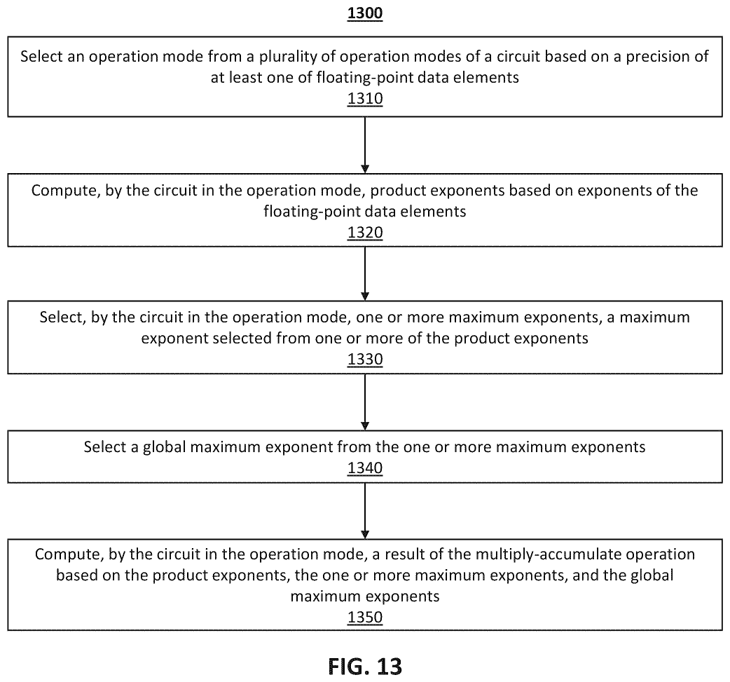

FIG. 13 is a flowchart showing a method 1300 of performing FPMAC operations, in accordance with various embodiments. The method 1300 may be performed by the compute block 330 in FIG. 3. Although the method 1300 is described with reference to the flowchart illustrated in FIG. 13, many other methods for performing FPMAC operations be used. For example, the order of execution of the steps in FIG. 13 may be changed. As another example, some of the steps may be changed, eliminated, or combined.

The compute block 330 selects 1310 an operation mode from a plurality of operation modes of a circuit based on a precision of at least one of the floating-point data elements. The circuit may be a circuit of a FPMAC unit, such as the FPMAC unit 600 in FIG. 6. In some embodiments, the operation mode corresponds to a first precision, such as FP8 precision. The plurality of operation mode further comprises another operation mode that corresponds to a second precision, such as FP16 precision. The second precision is higher than the first precision. In some embodiments, the floating-point data elements may include an activation and a weight of a deep learning operation, such as a convolution.

The compute block 330 computes 1320 product exponents based on exponents of the floating-point data elements. The compute block 330 may compute a product exponent by accumulating the exponents of two or more floating-point data elements.

The compute block 330 selects 1330 one or more maximum exponents. A maximum exponent is from one or more of the product exponents. In some embodiments, the compute block 330 may select, from two product exponents, the larger product exponent as the maximum exponent.

The compute block 330 selects 1340 a global maximum exponent from the one or more maximum exponents. In some embodiments, the compute block 330 performs one or more OR operations on bits in the one or more maximum exponents. The compute block 330 selects the global maximum exponent based on results of the one or more OR operations. In some embodiments, the compute block 330 selects the global maximum exponent based on a MSB of at least one of the one or more maximum exponents.

The compute block 330 computes 1350 a result of the multiply-accumulate operation based on the product exponents, the one or more maximum exponents, and the global maximum exponents. In some embodiments, the compute block 330 computes a product mantissa based on mantissas of the floating-point data elements, the maximum exponent, and the global maximum exponent. In an embodiment, the compute block 330 aligns one or more bits in a mantissa of a floating-point data element with one or more bits in a mantissa of another floating-point data element based on the maximum exponent.

In some embodiments, the one or more product exponents are computed in a first cycle. The product mantissa is computed in a second cycle. The compute block 330 shifts one or more bits in the product mantissa based on the global maximum exponent in the second cycle. Before the second cycle, the compute block 330 determines whether shifting the one or more bits would cause the product mantissa to exceed a bit width limit. In some embodiments, in response to determining that shifting the one or more bits would cause the product mantissa to exceed the bit width limit, the compute block 330 may skip computation of the product mantissa.

Example Computing Device

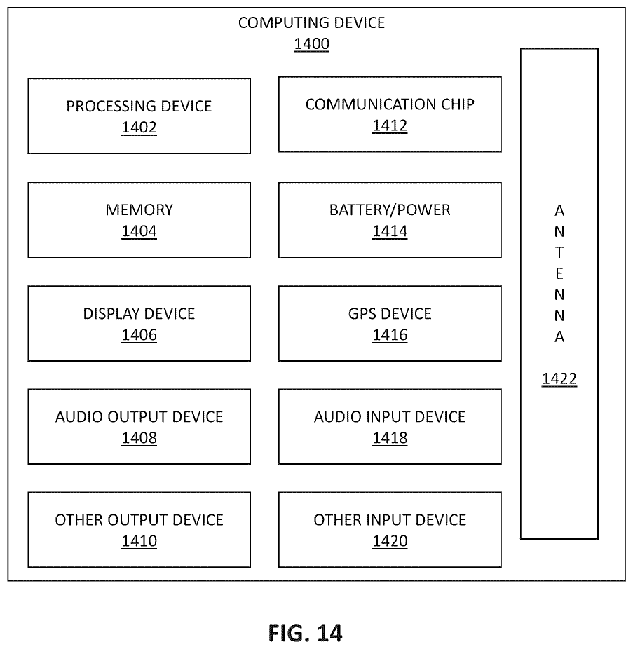

FIG. 14 is a block diagram of an example computing device 1400, in accordance with various embodiments. In some embodiments, the computing device 1400 may be used as at least part of the DNN accelerator 300 in FIG. 3. A number of components are illustrated in FIG. 14 as included in the computing device 1400, but any one or more of these components may be omitted or duplicated, as suitable for the application. In some embodiments, some or all of the components included in the computing device 1400 may be attached to one or more motherboards. In some embodiments, some or all of these components are fabricated onto a single system on a chip (SoC) die. Additionally, in various embodiments, the computing device 1400 may not include one or more of the components illustrated in FIG. 14, but the computing device 1400 may include interface circuitry for coupling to the one or more components. For example, the computing device 1400 may not include a display device 1406, but may include display device interface circuitry (e.g., a connector and driver circuitry) to which a display device 1406 may be coupled. In another set of examples, the computing device 1400 may not include an audio input device 1418 or an audio output device 1408 but may include audio input or output device interface circuitry (e.g., connectors and supporting circuitry) to which an audio input device 1418 or audio output device 1408 may be coupled.

The computing device 1400 may include a processing device 1402 (e.g., one or more processing devices). The processing device 1402 processes electronic data from registers and/or memory to transform that electronic data into other electronic data that may be stored in registers and/or memory. The computing device 1400 may include a memory 1404, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1404 may include memory that shares a die with the processing device 1402. In some embodiments, the memory 1404 includes one or more non-transitory computer-readable media storing instructions executable to perform operations, e.g., the method 1300 described above in conjunction with FIG. 13 or some operations performed by the compute block 330 described above in conjunction with FIG. 3. The instructions stored in the one or more non-transitory computer-readable media may be executed by the processing device 1402.

In some embodiments, the computing device 1400 may include a communication chip 1412 (e.g., one or more communication chips). For example, the communication chip 1412 may be configured for managing wireless communications for the transfer of data to and from the computing device 1400. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1412 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1412 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1412 may operate in accordance with other wireless protocols in other embodiments. The computing device 1400 may include an antenna 1422 to facilitate wireless communications and/or to receive other wireless communications (such as AM or FM radio transmissions).

In some embodiments, the communication chip 1412 may manage wired communications, such as electrical, optical, or any other suitable communication protocols (e.g., the Ethernet). As noted above, the communication chip 1412 may include multiple communication chips. For instance, a first communication chip 1412 may be dedicated to shorter-range wireless communications such as Wi-Fi or Bluetooth, and a second communication chip 1412 may be dedicated to longer-range wireless communications such as global positioning system (GPS), EDGE, GPRS, CDMA, WiMAX, LTE, EV-DO, or others. In some embodiments, a first communication chip 1412 may be dedicated to wireless communications, and a second communication chip 1412 may be dedicated to wired communications.

The computing device 1400 may include battery/power circuitry 1414. The battery/power circuitry 1414 may include one or more energy storage devices (e.g., batteries or capacitors) and/or circuitry for coupling components of the computing device 1400 to an energy source separate from the computing device 1400 (e.g., AC line power).

The computing device 1400 may include a display device 1406 (or corresponding interface circuitry, as discussed above). The display device 1406 may include any visual indicators, such as a heads-up display, a computer monitor, a projector, a touchscreen display, a liquid crystal display (LCD), a light-emitting diode display, or a flat panel display, for example.

The computing device 1400 may include an audio output device 1408 (or corresponding interface circuitry, as discussed above). The audio output device 1408 may include any device that generates an audible indicator, such as speakers, headsets, or earbuds, for example.

The computing device 1400 may include an audio input device 1418 (or corresponding interface circuitry, as discussed above). The audio input device 1418 may include any device that generates a signal representative of a sound, such as microphones, microphone arrays, or digital instruments (e.g., instruments having a musical instrument digital interface (MIDI) output).

The computing device 1400 may include a GPS device 1416 (or corresponding interface circuitry, as discussed above). The GPS device 1416 may be in communication with a satellite-based system and may receive a location of the computing device 1400, as known in the art.

The computing device 1400 may include another output device 1410 (or corresponding interface circuitry, as discussed above). Examples of the other output device 1410 may include an audio codec, a video codec, a printer, a wired or wireless transmitter for providing information to other devices, or an additional storage device.

The computing device 1400 may include another input device 1420 (or corresponding interface circuitry, as discussed above). Examples of the other input device 1420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1400 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1400 may be any other electronic device that processes data.

### Selected Examples

The following paragraphs provide various examples of the embodiments disclosed herein.

Example 1 provides an apparatus for a multiply-accumulate operation on floating-point data elements, the apparatus including a control module configured to select an operation mode from a plurality of operation modes of the apparatus based on a precision of at least one of the floating-point data elements; one or more product and alignment modules, a product and alignment module configured to operate under the operation mode by computing one or more product exponents based on exponents of the floating-point data elements, and selecting a maximum exponent from the one or more product exponents; and a maximum exponent module configured to select a global maximum exponent from one or more maximum exponents computed by the one or more product and alignment modules.

Example 2 provides the apparatus of example 1, where the selected operation mode corresponds to a first precision, and the plurality of operation mode further includes another operation mode that corresponds to a second precision, the second precision is higher than the first precision, and a bit width of a floating-point data element having the second precision equals a total bit width of two or more floating-point data elements having the first precision.

Example 3 provides the apparatus of example 1 or 2, where the product and alignment module is further configured to operate under the operation mode by computing a product mantissa based on mantissas of the floating-point data elements, the maximum exponent, and the global maximum exponent.

Example 4 provides the apparatus of example 3, where computing the product mantissa includes aligning one or more bits in a mantissa of a floating-point data element with one or more bits in a mantissa of another floating-point data element based on the maximum exponent.

Example 5 provides the apparatus of example 4, where aligning the one or more bits in the mantissa of the floating-point data element with the one or more bits in the mantissa of the another floating-point data element based on the maximum exponent includes determining a difference between the maximum exponent and an exponent of the floating-point data element or the another floating-point data element; and aligning the one or more bits in the mantissa of the floating-point data element with the one or more bits in the mantissa of the another floating-point data element based on the difference.

Example 6 provides the apparatus of any one of examples 3-5, where the one or more product exponents are computed before the product mantissa is computed.

Example 7 provides the apparatus of any one of examples 1-6, where the control module is further configured to generate a gating signal based on the global maximum exponent and a product exponent computed by another product and alignment module; and transmit the gating signal to the another product and alignment module, the gating signal preventing after the product and alignment module from computing any product mantissa.

Example 8 provides the apparatus of any one of examples 1-7, where the maximum exponent module includes one or more groups of OR operators configured to perform one or more OR operations on bits in the one or more maximum exponents, and the maximum exponent module is configured to select the global maximum exponent based on results of the one or more OR operations.

Example 9 provides the apparatus of any one of examples 1-8, further including one or more adders configured to accumulate one or more product mantissas from the one or more product and alignment modules, where a product mantissa is computed by the product and alignment module based on mantissas of the floating-point data elements, and the one or more product mantissa are aligned based on the global maximum exponent.

Example 10 provides the apparatus of example 9, further including a normalization module configured to compute a result of the multiply-accumulate operation on the floating-point data elements by normalizing an output of the one or more adders based on the global maximum exponent.

Example 11 provides a method for a multiply-accumulate operation on floating-point data elements, the method including selecting an operation mode from a plurality of operation modes of a circuit based on a precision of at least one of the floating-point data elements; computing, by the circuit in the operation mode, product exponents based on exponents of the floating-point data elements; selecting, by the circuit in the operation mode, one or more maximum exponents, a maximum exponent selected from one or more of the product exponents; selecting, by the circuit in the operation mode, a global maximum exponent from the one or more maximum exponents; and computing, by the circuit in the operation mode, a result of the multiply-accumulate operation based on the product exponents, the one or more maximum exponents, and the global maximum exponents.

Example 12 provides the method of example 11, where the operation mode corresponds to a first precision, and the plurality of operation modes further includes another operation mode that corresponds to a second precision, and the second precision is higher than the first precision.

Example 13 provides the method of example 11 or 12, where computing the result of the multiply-accumulate operation includes computing a product mantissa based on mantissas of the floating-point data elements, the maximum exponent, and the global maximum exponent.

Example 14 provides the method of example 13, where computing the product mantissa includes aligning one or more bits in a mantissa of a floating-point data element with one or more bits in a mantissa of another floating-point data element based on the maximum exponent.

Example 15 provides the method of example 13 or 14, where the one or more product exponents are computed in a first cycle, the product mantissa is computed in a second cycle, and the method further includes shifting one or more bits in the product mantissa based on the global maximum exponent in the second cycle; and before the second cycle, determining whether shifting the one or more bits would cause the product mantissa to exceed a bit width limit.

Example 16 provides the method of any one of examples 11-15, where selecting the global maximum exponent includes performing one or more OR operations on bits in the one or more maximum exponents; and selecting the global maximum exponent based on results of the one or more OR operations.

Example 17 provides the method of any one of examples 11-16, where selecting the global maximum exponent includes selecting the global maximum exponent based on a MSB of at least one of the one or more maximum exponents.

Example 18 provides one or more non-transitory computer-readable media storing instructions executable to perform operations, the operations including selecting an operation mode from a plurality of operation modes of the circuit based on a precision of floating-point data elements; computing one or more product exponents based on exponents of the floating-point data elements; selecting a maximum exponent from the one or more product exponents; and selecting a global maximum exponent from one or more maximum exponents computed by the one or more product and alignment modules.

Example 19 provides the one or more non-transitory computer-readable media of example 18, where the operation mode corresponds to a first precision, and the plurality of operation modes further includes another operation mode that corresponds to a second precision, and the second precision is higher than the first precision.

Example 20 provides the one or more non-transitory computer-readable media of example 18 or 19, where the operations further include computing a product mantissa based on mantissas of the floating-point data elements, the maximum exponent, and the global maximum exponent, where computing the product mantissa includes aligning one or more bits in a mantissa of a floating-point data element with one or more bits in a mantissa of another floating-point data element based on the maximum exponent.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus for multiply-accumulate operations on floating-point data elements, the apparatus comprising:
a control module configured to select an operation mode from a plurality of operation modes of the apparatus based on a precision of at least one of the floating-point data elements;
one or more product and alignment modules, a product and alignment module configured to operate under the operation mode by:
computing one or more product exponents based on exponents of the floating-point data elements, and
selecting a maximum exponent from the one or more product exponents; and
a maximum exponent module configured to select a global maximum exponent from one or more maximum exponents computed by the one or more product and alignment modules.

2. The apparatus of claim 1, wherein the selected operation mode corresponds to a first precision, and the plurality of operation mode further comprises another operation mode that corresponds to a second precision, the second precision is higher than the first precision, and a bit width of a floating-point data element having the second precision equals a total bit width of two or more floating-point data elements having the first precision.

3. The apparatus of claim 1, wherein the product and alignment module is further configured to operate under the operation mode by:
computing a product mantissa based on mantissas of the floating-point data elements, the maximum exponent, and the global maximum exponent.

4. The apparatus of claim 3, wherein computing the product mantissa comprises:
aligning one or more bits in a mantissa of a floating-point data element with one or more bits in a mantissa of another floating-point data element based on the maximum exponent.

5. The apparatus of claim 4, wherein aligning the one or more bits in the mantissa of the floating-point data element with the one or more bits in the mantissa of the another floating-point data element based on the maximum exponent comprises:
determining a difference between the maximum exponent and an exponent of the floating-point data element or the another floating-point data element; and
aligning the one or more bits in the mantissa of the floating-point data element with the one or more bits in the mantissa of the another floating-point data element based on the difference.

6. The apparatus of claim 3, wherein the one or more product exponents are computed before the product mantissa is computed.

7. The apparatus of claim 1, wherein the control module is further configured to:
generate a gating signal based on the global maximum exponent and a product exponent computed by another product and alignment module; and
transmit the gating signal to the another product and alignment module, the gating signal preventing after the product and alignment module from computing any product mantissa.

8. The apparatus of claim 1, wherein the maximum exponent module comprises one or more groups of OR operators configured to perform one or more OR operations on bits in the one or more maximum exponents, and the maximum exponent module is configured to select the global maximum exponent based on results of the one or more OR operations.

9. The apparatus of claim 1, further comprising:
one or more adders configured to accumulate one or more product mantissas from the one or more product and alignment modules,
wherein a product mantissa is computed by the product and alignment module based on mantissas of the floating-point data elements, and the one or more product mantissa are aligned based on the global maximum exponent.

10. The apparatus of claim 9, further comprising:
a normalization module configured to compute a result of the multiply-accumulate operation on the floating-point data elements by normalizing an output of the one or more adders based on the global maximum exponent.

11. A method for a multiply-accumulate operation on floating-point data elements, the method comprising:
selecting an operation mode from a plurality of operation modes of a circuit based on a precision of at least one of the floating-point data elements;
computing, by the circuit in the operation mode, product exponents based on exponents of the floating-point data elements;
selecting, by the circuit in the operation mode, one or more maximum exponents, a maximum exponent selected from one or more of the product exponents;
selecting, by the circuit in the operation mode, a global maximum exponent from the one or more maximum exponents; and
computing, by the circuit in the operation mode, a result of the multiply-accumulate operation based on the product exponents, the one or more maximum exponents, and the global maximum exponents.

12. The method of claim 11, wherein the operation mode corresponds to a first precision, and the plurality of operation modes further comprises another operation mode that corresponds to a second precision, and the second precision is higher than the first precision.

13. The method of claim 11, wherein computing the result of the multiply-accumulate operation comprises:
computing a product mantissa based on mantissas of the floating-point data elements, the maximum exponent, and the global maximum exponent.

14. The method of claim 13, wherein computing the product mantissa comprises:
aligning one or more bits in a mantissa of a floating-point data element with one or more bits in a mantissa of another floating-point data element based on the maximum exponent.

15. The method of claim 13, wherein the one or more product exponents are computed in a first cycle, the product mantissa is computed in a second cycle, and the method further comprises:
shifting one or more bits in the product mantissa based on the global maximum exponent in the second cycle; and
before the second cycle, determining whether shifting the one or more bits would cause the product mantissa to exceed a bit width limit.

16. The method of claim 11, wherein selecting the global maximum exponent comprises:
performing one or more OR operations on bits in the one or more maximum exponents; and
selecting the global maximum exponent based on results of the one or more OR operations.

17. The method of claim 11, wherein selecting the global maximum exponent comprises:
selecting the global maximum exponent based on a most significant bit of at least one of the one or more maximum exponents.

18. One or more non-transitory computer-readable media storing instructions executable to perform operations, the operations comprising:
selecting an operation mode from a plurality of operation modes of the circuit based on a precision of floating-point data elements for a multiply-accumulate operation;
computing one or more product exponents based on exponents of the floating-point data elements;
selecting a maximum exponent from the one or more product exponents; and
selecting a global maximum exponent from one or more maximum exponents computed by the one or more product and alignment modules.

19. The one or more non-transitory computer-readable media of claim 18, wherein the operation mode corresponds to a first precision, and the plurality of operation modes further comprises another operation mode that corresponds to a second precision, and the second precision is higher than the first precision.

20. The one or more non-transitory computer-readable media of claim 18, wherein the operations further comprise:
computing a product mantissa based on mantissas of the floating-point data elements, the maximum exponent, and the global maximum exponent,
wherein computing the product mantissa comprises aligning one or more bits in a mantissa of a floating-point data element with one or more bits in a mantissa of another floating-point data element based on the maximum exponent.
